(19) United States
(12) Patent Application Publication
(10) Pub. No.: US 2024/0137378 A1
(43) Pub. Date: Apr. 25, 2024

(54) User Importance Metric for Email

(71) Applicant: Darktrace Holdings Limited, Cambridge (GB)

(72) Inventors: Philip Sellars, Cambridge (GB); Steven Haworth, Cambridge (GB); Stephen Pickman, Huntingdon (GB)

(21) Appl. No.: 18/400,640

(22) Filed: Dec. 29, 2023

Related U.S. Application Data
(63) Continuation-in-part of application No. 17/966,708, filed on Oct. 14, 2022.
Application No. 17/966,708 is a continuation of application No. 16/732,644, filed on Jan. 2, 2020, now Pat. No. 11,477,222.
Application No. 16/732,644 is a continuation-in-part of application No. 16/278,932, filed on Feb. 19, 2019, now Pat. No. 11,606,373.
(60) Provisional application No. 63/436,425, filed on Dec. 30, 2022.
(60) Provisional application No. 63/317,157, filed on Mar. 7, 2022.
(60) Provisional application No. 62/796,507, filed on Jan. 24, 2019.
(60) Provisional application No. 62/632,623, filed on Feb. 20, 2018.

(51) Int. Cl. H04L 9/40; G06N 20/00

(52) U.S. Cl. CPC H04L 63/1425; G06N 20/00; H04L 63/1416; H04L 2101/37

(57) ABSTRACT

The email system utilizes statistical analysis to assign an importance score to each user within an organization based on their email activity. The score is continuously updated to reflect changes in email flow and user status. The system identifies high-profile individuals who are likely to be targeted by external actors and assigns them a higher importance score. It also adjusts the scores based on several dampening factors related to the user's email behavior. The system uses these scores to determine vip users and tailors its response to malicious emails accordingly. Vip-specific threat handling rules, which are less disruptive or intrusive, are applied when a malicious email targets a vip user. The system intelligently derives user importance information, allowing it to identify a larger subset of important users within an organization. This approach minimizes disruption, tailors actions to key stakeholders, and does not require significant manual tuning.

### RELATED APPLICATIONS

This application claims priority to and the benefit of under 35 USC 119 of U.S. provisional patent application titled “A Cyber Security System,” filed Dec. 30, 2022, Ser. No. 63/436,425. This application also claims priority to and the benefit of under 35 USC 119 of U.S. provisional patent application titled “A Cyber Security System,” filed Mar. 7, 2023, Ser. No. 63/317,157. This application also claims priority to and the benefit of under 35 USC 120 as a continuation in part of U.S. patent application titled “A Cyber Threat Defense System Protecting Email Networks with Machine Learning Models using a Range of Metadata from Observed Email Communications” filed Oct. 14, 2022, Ser. No. 17/966,708, which claims priority under 35 USC 120 from U.S. patent application Ser. No. 16/732,644 titled “A cyber threat defense system protecting email networks with machine learning models using a range of metadata from observed email communications,” filed 2 Jan. 2020, which claimed priority to and the benefit of 35 USC 119 of U.S. provisional patent application titled “A Cyber Security System,” filed Jan. 24, 2019, Ser. No. 62/796,507 as well as This application also claims claimed priority to and the benefit of under 35 USC 120 of U.S. patent application titled “A cyber threat defense system protecting email networks with machine learning models” filed Feb. 19, 2019, Ser. No. 16/278,932, which claims priority to provisional patent application titled “A cyber threat defense system with various improvements,” filed Feb. 20, 2018, Ser. No. 62/632,623, all of which are incorporated herein by reference in their entirety. all of these are incorporated herein by reference in their entirety.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments of the design provided herein generally relate to adaptive email security systems. In an embodiment, the system automatically identifies the important users within the organization based on incoming and outgoing emails.

### BACKGROUND

In the cyber security environment, firewalls, endpoint security methods and other tools such as SIEMs and sandboxes are deployed to enforce specific policies and provide protection against certain threats. These tools currently form an important part of an organization's cyber defense strategy, but they are insufficient in the new age of cyber threats where intelligent cyber threats modify their behavior and actively seek to avoid detection. Cyber threats, including email borne cyber threats, can be subtle and rapidly cause harm to a network. Having an automated response can allow a system to rapidly counter these threats.

Conventional email security systems often rely on static methods such as analyzing titles or organization charts to determine user importance, which can be unreliable due to the fluidity of importance associated with a title across different types of organizations, industries, countries, languages, and cultures. These systems often cause frustration among key stakeholders due to the severity of actions taken and the negative perception associated with missed detections. Additionally, these systems can be complex to deploy and require significant manual tuning, which is not feasible in large environments. There is a need for a dynamic, adaptive, and intelligent system that can automatically determine user importance based on email flow within the company, tailor actions and action severity towards important users, and require minimal manual tuning.

### SUMMARY

A cyber security appliance and its models and modules protect a system against cyber threats including attacks and dangers presented through the email domain. The cyber security appliance can protect an email system with components including a user importance scoring module, a very important person (vip) determination module, one or more machine learning models, an autonomous response module, and an assessment module.

The user importance scoring module is configured to calculate an importance score of a user of the email system based on a number of new inbound senders associated with one or more inbound emails having the user as a recipient over a set period of time and 1) one or more enhancing factors each of which increases the importance score of the user, 2) one or more dampening factors each of which reduces the importance score of the user, or 3) a combination thereof. A greater number of the new inbound senders corresponds to a higher importance score that corresponds to a higher level of importance of the user. The vip determination module is communicatively coupled to the user importance scoring module. The vip determination module is configured to determine whether the user is a vip user based on the calculated importance score of the user. The user is characterized to be a vip user (e.g., a type of user in the system) when the calculated importance score of the user is greater than a threshold amount, and the user is determined not to be a vip user when the calculated importance score of the user is less than the threshold amount. The one or more machine learning models are configured to analyze the one or more inbound emails having the user as a recipient and then output results to detect malicious emails. The autonomous response module is communicatively coupled to the vip determination module. The autonomous response module is configured to cause one or more autonomous actions to be taken to mitigate emails deemed malicious by the one or more machine learning models when a threat risk parameter from the assessment module cooperating with the one or more machine learning models is equal to or above an actionable threshold. The one or more autonomous actions are based on one or more vip-specific rules if the user is characterized to be the vip user, and the one or more autonomous actions are based on one or more non-vip-specific rules if the user is determined not to be a vip user. Any software utilized by the user importance scoring module, the vip determination module, the machine learning models, the autonomous response module, and the assessment module is configured to be stored on one or more non-transitory machine readable mediums in a format to be executed by one or more processor units.

These and other features of the design provided herein can be better understood with reference to the drawings, description, and claims, all of which form the disclosure of this patent application.

### DRAWINGS

The drawings refer to some embodiments of the design provided herein in which:

FIG. 1A illustrates a block diagram of an embodiment of a cyber security appliance with a cyber-threat analyst module that references machine learning models that are trained on the normal pattern of life of email activity and user activity associated with at least the email system, where the assessment module cooperating with a cyber threat analysis module determines a threat risk parameter that factors in ‘the likelihood that a chain of one or more unusual behaviors of the email activity and user activity under analysis fall outside of derived normal benign behavior;’ and thus, are likely malicious behavior.

FIG. 1B illustrates a block diagram of a portion of FIG. 1A showing an embodiment of a cyber security appliance with an email module with an email campaign detector, an email similarity classifier, a targeted campaign classifier, a self-correcting similarity classifier, and an impersonation detector cooperating with one or more machine learning models to detect a cyber threat introduced via an email.

FIG. 1C illustrates a block diagram of a portion of FIG. 1A showing an embodiment of a cyber security appliance with an email module that has a very important person (vip) determination module cooperating with one or more machine learning models.

FIGS. 2A and 2B illustrate flow diagrams of an embodiment of an email similarity scoring generated by the machine learning models when comparing an incoming email, in this example based on a semantic similarity of multiple aspects of the email to a cluster of different metrics derived from known bad emails to derive a similarity score between an email under analysis and the cluster of different metrics derived from known bad emails.

FIG. 2C illustrates the handling of malicious email threats based on whether the targeted user is a vip user.

FIG. 3 illustrates a block diagram of an embodiment of the cyber security appliance with probes and detectors monitoring email activity and network activity to feed this data to correlate causal links between these activities to supply this input into the cyber-threat analysis.

FIG. 4 illustrates a flow diagram of an embodiment of the cyber security appliance referencing one or more machine learning models trained on gaining an understanding of a plurality of characteristics on an email itself and its related data including classifying the properties of the email and its metadata.

FIG. 5 illustrates an example of the network module informing the email module of a computer's network activity prior to the user of that computer receiving an email containing content relevant to that network activity.

FIG. 6 illustrates an example of the network module informing the email module of the deduced pattern of life information on the web browsing activity of a computer prior to the user of that computer receiving an email that contains content which is not in keeping with that pattern of life.

FIG. 7 illustrates a block diagram of an embodiment of an example chain of unusual behavior for the email(s) in connection with the rest of the network under analysis and how the cyber-threat analyst module cooperating with the assessment module and the machine learning models determine a threat risk parameter that factors in how the chain of unusual behaviors correlate to potential cyber threats.

FIG. 8 illustrates a block diagram of an embodiment of an example window of the user interface with an inbox-style view of all emails coming in/out of an email domain and the cyber security characteristics known about one or more e-mails under analysis.

FIG. 9 illustrates a block diagram of an embodiment of example autonomous actions that the autonomous response module can be configured to take without a human initiating that action.

FIGS. 10A and 10B illustrate a flow chart of an embodiment of a method for a cyber security appliance to protect an email system.

FIG. 10C illustrates a flow chart of an embodiment of a method for a cyber security appliance to protect an email system.

FIG. 11 illustrates an example cyber security appliance protecting an example network.

FIG. 12 illustrates a block diagram of an embodiment of one or more computing devices that can be a part of an embodiment of the Artificial Intelligence based cyber security appliance discussed herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, number of servers in a system, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as a first server, can be made. However, the specific numeric reference should not be interpreted as a literal sequential order but rather interpreted that the first server is different than a second server. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

In general, Artificial Intelligence analyzes email information and potentially IT network information to detect a cyber threat. The email campaign detector checks whether clustered emails with similar characteristics are part of a targeted campaign of malicious emails. An email similarity classifier analyzes a group of emails in order to cluster emails with similar characteristics in the group of emails. A targeted campaign classifier analyzes the clustered emails with similar characteristics to check whether the clustered emails with similar characteristics are a) coming from a same threat actor b) going to a same intended target, and c) any combination of both, as well as ii) verify whether the clustered emails with similar characteristics are deemed malicious. The email campaign detector uses information from the email similarity classifier and the targeted campaign classifier in order to provide an early warning system of a targeted campaign of malicious emails is underway. The one or more machine learning models analyze the emails in the group and then output results to detect malicious emails. The email campaign detector cooperates with the one or more machine learning models to identify emails that are deemed malicious by the output results of the machine learning analysis from the models. The autonomous response module can then cause one or more autonomous actions to be taken to mitigate emails deemed malicious by the one or more machine learning models when a threat risk parameter from an assessment module and cyber threat analyst module cooperating with the one or more machine learning models is equal to or above an actionable threshold. In addition, the email campaign detector generates a notice communicated to one or more IT security personnel when the email campaign detector determines that the targeted campaign of malicious emails is occurring/underway.

A cyber security appliance with an email campaign detector can apply the techniques and mechanisms herein to provide better detection of email campaigns, better detection of Spoofs, more generally higher fidelity, and minimizing alert fatigue.

In one embodiment, an importance score can be calculated for each user within an email system of an organization based on their email activity and statistical analysis. The score is continuously updated to reflect changes in email flow and user status. The system operates under the assumption that high-profile individuals are more likely to be targeted by external actors, so users who receive a high volume of unsolicited, targeted external emails are considered important. The email behavior of a user is factored into the score, with certain behaviors associated with customer-facing roles or HR/recruitment roles leading to a reduced score. The system identifies new inbound senders based on inbound emails and assigns an initial importance score to each user. The score is increased based on the quantity of emails targeted at just the user or a small number of users, and if the emails are deemed malicious.

The system also adjusts the importance scores for users based on several dampening factors. These factors include the frequency of the user sending outbound email communication to new external senders, the regularity of a user sending high frequency amount outbound emails (e.g. a greater frequency compared to the average user), whether a user sends few or no outbound emails over a certain period, the frequency of a user's email communications with email addresses hosted at free email domains, whether a user is rarely included in email threads with external participants by their colleagues, and whether a user is often included in email threads that do not involve other high-importance colleagues. The system uses the importance scores to determine whether a user is a very important person (vip) user. If a malicious email targets a vip user, the system takes appropriate action based on vip-specific threat handling rules, which can specify less disruptive or intrusive measures. Conversely, if a malicious email targets a non-vip user, the system takes appropriate action based on regular, non-VIP-specific threat handling rules. This ensures that the system's response is tailored to the importance of the user, minimizing disruption for vip users while still maintaining robust security measures. The assignment of importance scores to the users is an automatic process and does not require significant manual tuning, making it suitable for large organizations. The system intelligently derives the user importance information, rather than relying on simplistic hard-coding or rigid conceptions of seniority linked to organization charts or job titles. This allows the system to identify the larger subset of important users that may exist in an organization, not just those the system administrators may consider important.

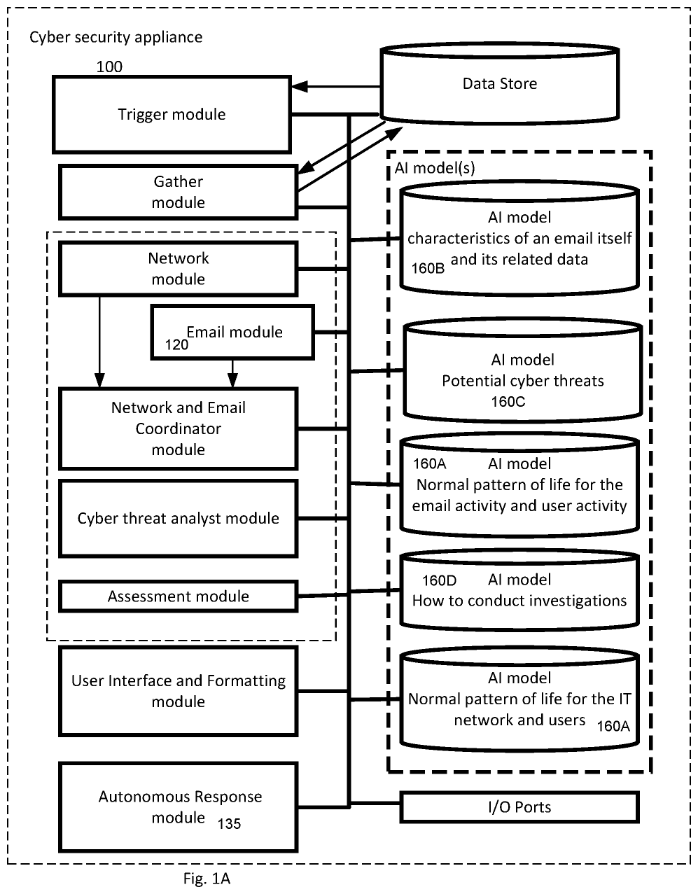

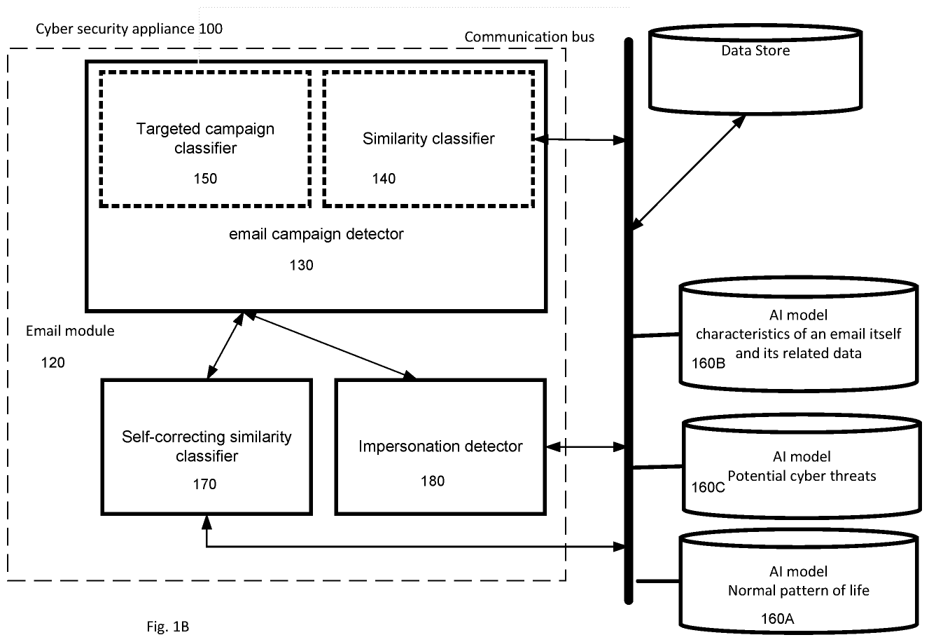

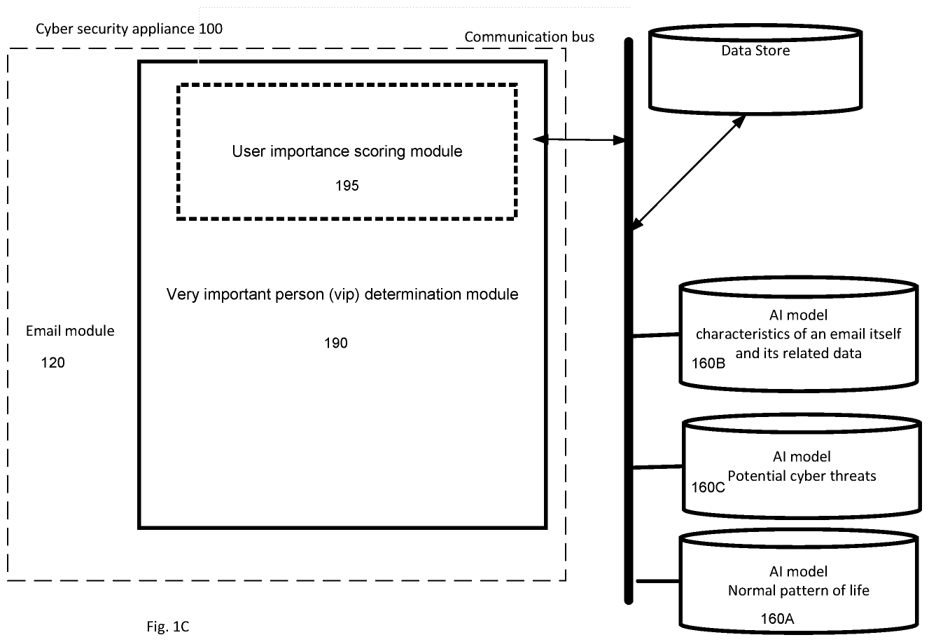

FIG. 1A illustrates a block diagram of an embodiment of a cyber security appliance with a cyber-threat analyst module that references machine learning models that are trained on the normal pattern of life of email activity and user activity associated with at least the email system, where the cyber-threat analyst module cooperating with the assessment module determines a threat risk parameter that factors in ‘the likelihood that a chain of one or more unusual behaviors of the email activity and user activity under analysis fall outside of derived normal benign behavior;’ and thus, are likely malicious behavior. The cyber security appliance can protect an email system with components including an email campaign detector 130, one or more machine learning models 160A-160D, a cyber-threat analyst module, an assessment module, an autonomous response module 135, an email campaign detector 130, an email similarity classifier 140, a targeted campaign classifier 150, a self-correcting similarity classifier 170, an impersonation detector 180, a vip determination module 190, a communication module with input-output ports, and other modules and models.

The cyber security appliance can use the machine learning models 160A that are trained on a normal pattern of life of email activity and user activity associated with an email system. A cyber-threat analyst module may reference the machine learning models 160A that are trained on the normal pattern of life of email activity and user activity. A determination is made of a threat risk parameter that factors in the likelihood that a chain of one or more unusual behaviors of the email activity and user activity under analysis fall outside of derived normal benign behavior. The autonomous response module 135 can be used, rather than a human taking an action, to cause one or more autonomous actions to be taken to contain the cyber-threat when the threat risk parameter from the assessment module is equal to or above an actionable threshold.

The cyber security appliance 100 may protect against cyber threats from an e-mail system as well as its network. The cyber security appliance 100 may also include components such as i) a trigger module, ii) a gather module, iii) a data store, iv) a network module, v) an email module 120, vi) a network & email coordinator module, vii) a cyber-threat analyst module, viii) a user interface and display module, ix) an autonomous response module 135, and x) one or more machine learning models 160A-160D including a first Machine learning model trained on characteristics of an email itself and its related data 160B, a second Machine learning model 160C trained on potential cyber threats, and one or more machine learning models 160A each trained on the pattern of life of different users, devices, IT and email activities and interactions between entities in the system (which includes machine learning models that are trained on the normal pattern of life of email activity and user activity associated with at least the email system), and other aspects of the system, as well as xv) other similar components in the cyber security appliance 100.

A trigger module cooperating with the email module 120, the network module, and the machine learning models 160A that are trained on the normal pattern of life of email activity and user activity associated with at least the email system may detect time stamped data indicating one or more i) events and/or ii) alerts from 1) unusual or II) suspicious behavior/activity are occurring and then triggers that something unusual is happening. The email module 120 cooperating with the machine learning model trained on email characteristics can evaluate the characteristics of the emails and find malicious emails and then triggers a model breach and possibly an alert. Accordingly, the gatherer module is triggered by specific events and/or alerts of i) an abnormal behavior, ii) a suspicious activity, and iii) any combination of both. The data may be gathered on the deployment as it comes in from the network as well as historic data from a data store when the traffic is observed. The scope and wide variation of data available in this location results in good quality data for analysis. The collected data is passed to the cyber-threat analyst module.

The gatherer module may consist of multiple automatic data gatherers that each look at different aspects of the data depending on the particular hypothesis formed for the analyzed event and/or alert. The data relevant to each type of possible hypothesis will be automatically pulled by scripted algorithms and/or APIs that push information from additional external and internal sources. Some data is pulled or retrieved by the gatherer module for each possible hypothesis. A feedback loop of cooperation occurs between the gatherer module, the email module 120 monitoring email activity, the network module monitoring network activity, the email campaign detector 130, the email similarity classifier 170, the targeted campaign classifier 150, the self-correcting similarity classifier 170, the impersonation detector 180, the cyber-threat analyst module 125, all cooperating with one or more machine learning models on different aspects of this process. The cyber-threat analyst module 125 is configured to detect cyber threats and conduct hypotheses about potential threats and conduct investigations to prove or disprove a hypothesis of a possible cyber threat attack. Each hypothesis of typical cyber threats, e.g. human user insider attack/inappropriate network and/or phishing emails, malicious software/malware attack, etc., can have various supporting points of data and other metrics associated with that possible cyber threat, and a machine learning algorithm will look at the relevant points of data to support or refute that particular hypothesis of what the suspicious activity and/or abnormal behavior related for each hypothesis on what the suspicious activity and/or abnormal behavior relates to. Networks have a wealth of data and metrics that can be collected and then the mass of data is filtered/condensed down into the important features/salient features of data by the gatherers.

In an embodiment, the network module, the email module 120, and the network & email coordinator module may be portions of the cyber-threat analyst module or separate modules by themselves. In an embodiment, the email campaign detector 130, an email similarity classifier 140, a targeted campaign classifier 150, a self-correcting similarity classifier 170, an impersonation detector 180, and a vip determination module 190 also may be separate modules or combined into portions of a larger version of the email module 120. FIG. 1B illustrates a block diagram of a portion of FIG. 1A showing an embodiment of a cyber security appliance 100 with an email module 120 that has an email campaign detector 130, an email similarity classifier 140, a targeted campaign classifier 150, a self-correcting similarity classifier 170, and an impersonation detector 180 cooperating with one or more machine learning models 160A-160D. FIG. 1C illustrates a block diagram of a portion of FIG. 1A showing an embodiment of a cyber security appliance 100 with an email module 120 that has a vip determination module 190 cooperating with one or more machine learning models 160A-160D.

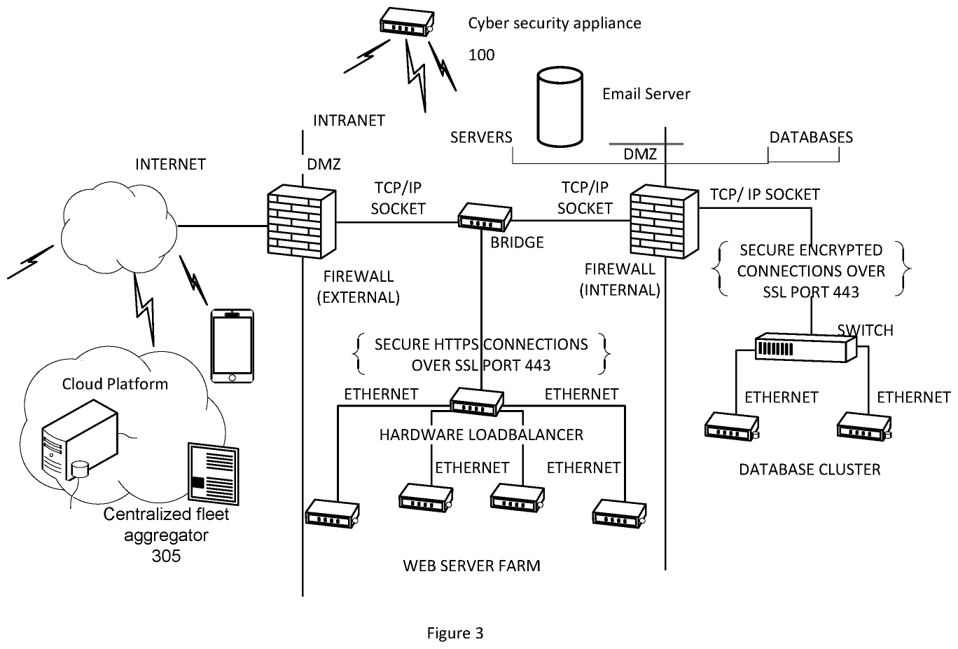

The cyber security appliance 100 uses various probes to collect the user activity and the email activity and then feed that activity to the data store and as needed to the cyber-threat analyst module and the machine learning models 160A-160D. The cyber-threat analyst module uses the collected data to draw an understanding of the email activity and user activity in the email system as well as updates a training for the one or more machine learning models 160A trained on this email system and its users. For example, email traffic can be collected by putting probe hooks into the e-mail application, the email server, such as Outlook or Gmail, and/or monitoring the internet gateway from which the e-mails are routed through. Additionally, probes may collect network data and metrics via one of the following methods: port spanning the organization's existing network equipment; inserting or re-using an in-line network tap, and/or accessing any existing repositories of network data (e.g., See FIG. 3).

The email module 120 and the network module communicate and exchange information with the set of four or more machine learning models 160A-160D. The two or more modules in the cyber security appliance also are configured to receive information from the probes, including a set of detectors, to provide at least a wide range of metadata from observed email communications in the email domain. The cyber threat analyst module 125 cooperates with the two or more modules to analyze the wide range of metadata from the observed email communications.

The cyber threat analyst module 125 can receive an input from two or more modules of the modules in the cyber security appliance. The cyber threat analyst module 125 factors in the input from at least each of these analyses above in a wide range of metadata from observed email communications to detect and determine when a deviation from the normal pattern of life of email activity and user activity associated with the network and its email domain is occurring and then cooperate with the autonomous response module 135 to determine what autonomous action to take to remedy against a potentially malicious email. The cyber-threat analyst module may also reference and communicate with one or more machine learning models 160C trained on cyber threats in the email system. The cyber-threat analyst module may reference the machine learning models that are trained on the normal pattern of life of email activity and user activity associated with the email system 160A. The cyber-threat analyst module can reference these various trained machine learning models 160A-160D and data from the network module, the email module 120, and the trigger module. The cyber-threat analyst module cooperating with the assessment module can determine a threat risk parameter that factors in how the chain of unusual behaviors correlate to potential cyber threats and ‘what is a likelihood of this chain of one or more unusual behaviors of the email activity and user activity under analysis that fall outside of derived normal benign behavior;’ and thus, is malicious behavior.

The one or more machine learning models 160A-160D can be self-learning models using unsupervised learning and trained on a normal behavior of different aspects of the system, for example, email activity and user activity associated with an email system. The self-learning models of normal behavior are regularly updated. The self-learning model of normal behavior is updated when new input data is received that is deemed within the limits of normal behavior. A normal behavior threshold is used by the model as a moving benchmark of parameters that correspond to a normal pattern of life for the computing system. The normal behavior threshold is varied according to the updated changes in the computer system allowing the model to spot behavior on the computing system that falls outside the parameters set by the moving benchmark.

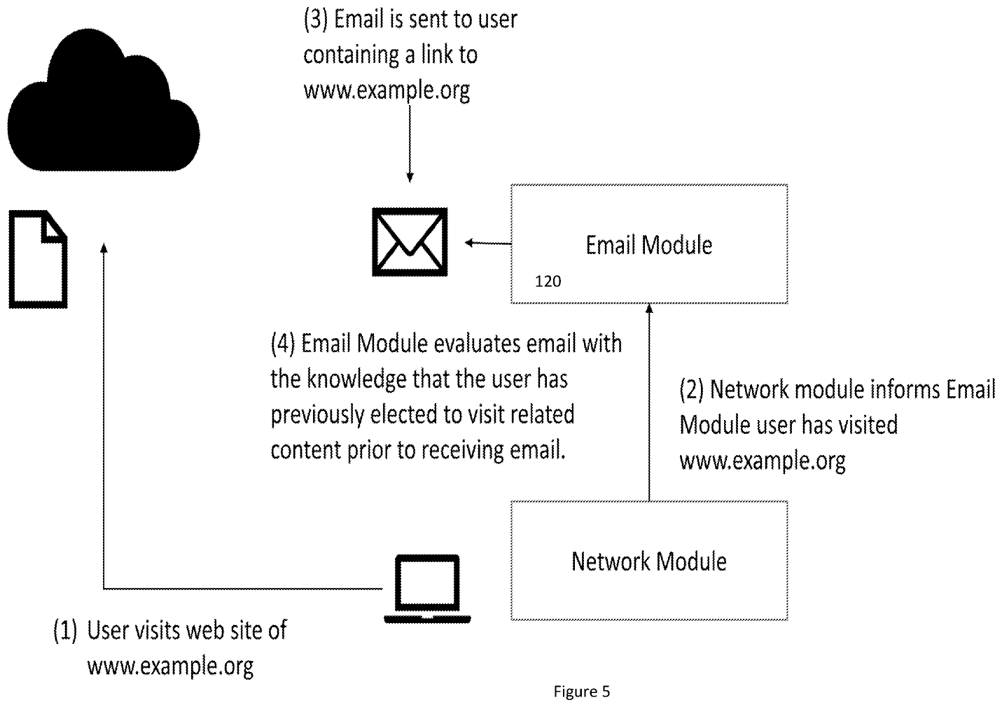

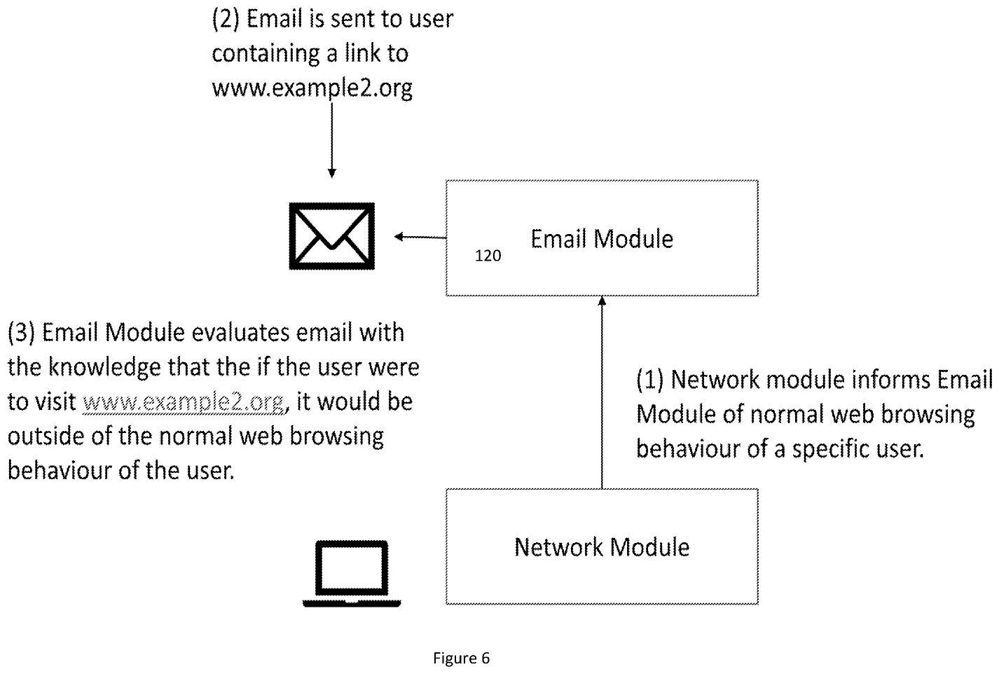

FIGS. 5 and 6 illustrate a block diagram of an embodiment of the cyber-threat analyst module cooperating with the assessment module and the machine learning models 160A-160D comparing the analyzed metrics on the user activity and email activity compared to their respective moving benchmark of parameters that correspond to the normal pattern of life of email activity and user activity associated with the network and its email domain used by the self-learning machine learning models 160A and the corresponding potential cyber threats. The cyber threat analyst module 125 can then determine, in accordance with the analyzed metrics and the moving benchmark of what is considered normal behavior, a cyber-threat risk parameter indicative of a likelihood of a cyber-threat.

Referring back to FIGS. 1A and 1B, the cyber security appliance 100 may also include one or more machine learning models 160B trained on gaining an understanding of a plurality of characteristics on an email itself and its related data including classifying the properties of the email and its metadata. The cyber-threat analyst module can also reference the machine learning models 160B trained on an email itself and its related data to determine if an email or a set of emails under analysis have potentially malicious characteristics. The cyber-threat analyst module can also reference the machine learning models 160C trained on cyber threats and their characteristics and symptoms to determine if an email or a set of emails under analysis are likely malicious. The cyber-threat analyst module can also factor this email characteristics analysis into its determination of the threat risk parameter.

The network module cooperates with the one or more machine learning models 160A trained on a normal behavior of users, devices, and interactions between them, on a network, which is tied to the email system. The cyber-threat analyst module can also factor this network analysis into its determination of the threat risk parameter.

A user interface has one or more windows to display network data and one or more windows to display emails and cyber security details about those emails through the same user interface on a display screen, which allows a cyber professional to pivot between network data and email cyber security details within one platform, and consider them as an interconnected whole rather than separate realms on the same display screen.

The cyber security appliance 100 may use at least four separate machine learning models 160A-160D. The machine learning models 160A may be trained on specific aspects of the normal pattern of life for the system such as devices, users, network traffic flow, outputs from one or more cyber security analysis tools analyzing the system, etc. One or more machine learning models 160C may also be trained on characteristics and aspects of all manner of types of cyber threats. One or more machine learning models may also be trained on the characteristics of emails themselves 160C. One or more machine learning models 160D may also be trained on how and steps to do to conduct cyber threat investigations.

The email module 120 monitoring email activity and the network module monitoring network activity may both feed their data to a network & email coordinator module to correlate causal links between these activities to supply this input into the cyber-threat analyst module. The application of these causal links is demonstrated in the block diagrams of FIG. 5 and FIG. 6. The cyber-threat analyst module 125 can also factor this network activity link to a particular email causal link analysis into its determination of the threat risk parameter (see FIG. 6).

Again, the cyber threat analyst module 125 is configured to receive an input from at least each of the two or more modules above. The cyber threat analyst module 125 factors in the input from each of these analyses above to use a wide range of metadata from observed email communications to detect and determine when the deviation from the normal pattern of life of email activity and user activity associated with the network and its email domain is occurring, and then determine what autonomous action to take to remedy against a potentially malicious email. Again, the cyber threat analyst module 125 factors in the input from each of these analyses above including comparing emails to the machine learning model trained on characteristics of an email itself and its related data to detect and determine when the deviation indicates a potentially malicious email.

The cyber threat analyst module 125 detects deviations from a normal pattern of life of email activity and user activity associated with the network and its email domain based on at least one or more AI models determining the normal pattern of life of email activity and user activity associated with the network and its email domain; rather than, ahead of time finding out what a ‘bad’ email signature looks like and then preventing that known bad’ email signature.

The cyber security appliance 100 takes actions to counter detected potential cyber threats. The autonomous response module 135, rather than a human taking an action, can be configured to cause one or more autonomous actions to be taken to contain the cyber-threat when the threat risk parameter from the cyber threat analyst module 125 is equal to or above an actionable threshold. The cyber-threat analyst module cooperates with the autonomous response module 135 to cause one or more autonomous actions to be taken to contain the cyber threat, in order to improve computing devices in the email system by limiting an impact of the cyber-threat from consuming unauthorized CPU cycles, memory space, and power consumption in the computing devices via responding to the cyber-threat without waiting for some human intervention.

Referring to FIG. 1B, the cyber security appliance 100 can have an email module 120 that has an email campaign detector 130, an email similarity classifier 140, a targeted campaign classifier 150, a self-correcting similarity classifier 170, and an impersonation detector 180 cooperating with one or more machine learning models 160A-160D.

An Early Warning System to Predict a Sustained and Malicious Email Campaign

The email campaign detector 130 can use machine learning to cluster similar emails deemed malicious. The email campaign detector 130 has 1) an email similarity classifier 140 configured to analyze a group of emails, under analysis, in order to cluster emails with similar characteristics in the group of emails. The email campaign detector 130 has 2) a targeted campaign classifier 150 configured to i) analyze the clustered emails with similar characteristics to check whether the clustered emails with similar characteristics are a) coming from a same threat actor b) going to a same intended recipient, and c) any combination of both. The targeted campaign classifier 150 will also verify whether the clustered emails with similar characteristics are deemed malicious. The email campaign detector 130 is configured to analyze information from the email similarity classifier 140 and the targeted campaign classifier 150, which when combined can cluster the corresponding emails into a campaign of malicious emails. The email campaign detector 130 is configured to analyze information from the email similarity classifier 140 and the targeted campaign classifier 150 in order to provide an early warning system of a targeted campaign of malicious emails. An email campaign detector 130 working in a corporate environment is configured to cluster inbound emails that have similar indices/metrics as well as from a same source, e.g., 1) sent from the same person, entity, group, 2) sent from and/or sent to a common specific geographic area, 3) sent from and/or sent to a common entity (henceforth an email campaign).

The email campaign detector 130 can check when there are changes over time changes in the AI modeling and its sophisticated anomaly scoring. The early warning system in the email campaign detector 130 can start looking for trends and anomalies within the AI model breaches. Each client's cyber security appliance has a set of AI models and policies that can be breached.

The targeted campaign classifier 150 can determine a likelihood that two or more highly similar emails would be i) sent from or ii) received by a collection of users in the email domain under analysis in the same communication or in multiple communications within a substantially simultaneous time period. The targeted campaign classifier 150 module can determine a likelihood that two or more highly similar emails that are being i) sent from or ii) received by a collection of users in the email domain under analysis in the same communication or in a given time frame, based on at least i) historical patterns of communication between those users, and ii) how rare the collection of users under analysis all would send and/or receive this highly similar email in roughly the substantially simultaneous time frame. The normal pattern of life of email activity and user activity associated with the network and its email domain can be used by the targeted campaign classifier 150 on a mass email association to create a map of associations between users in the email domain to generate the probabilistic likelihood that the two or more users would be included in the highly similar emails.

The cloud platform can aggregate those targeted campaigns of malicious emails centrally with a centralized fleet aggregator 305. (See FIG. 3) The centralized fleet aggregator 305 looks for these trends, anomalies, and then from that the centralized mechanism can drive detected trends like autonomous action responses by transmitting that information back out to local cyber security appliances deployed throughout the fleet. The aggregation of that data which is fed to an AI classifier to ascertain whether this email campaign is occurring in certain region(s), across certain industries, sent from a same entity, sent from a same geographic location, etc. The centralized fleet aggregator 305 puts this information into a format which is usable for the fleet of deployed cyber security appliances in general, as well as notices sent to marketing and customer support.

The email similarity classifier 140 is configured to create the cluster of emails with similar characteristics by tracking and analyzing a set of three or more indices/metrics in each of the emails making up the group of emails. The individual indices/metrics within that set can vary and be different than other instances of that index in another email but yet still be deemed similar because at least a majority of the indices match up in the set of three or more indices. Thus, the email similarity classifier 140 is configured to create a set of three or more similar indices/metrics and in some instances four or more similar indices, and some five or more similar indices. The individual indices/metrics within that set can vary and be different than other instances of those indices in another email but still be deemed similar because at least a majority (e.g., 2 of 3, 3 of 5, 11 of 20) of the indices match up in the set of three or more indices. Thus, a set of indices/metrics is looked at, and individually within that set of individual indices/metrics, an individual index can change but there is a consistency of similarity within that composite set of metrics that the email similarity classifier 140 is looking at to classify them as similar emails. The targeted campaign classifier 150 and email campaign detector 130 of the email campaign detector 130 derive overall changes rather than merely checking a list of identified known-bad, which results in a nuanced approach that catches more sophisticated email threats and/or email campaigns.

The email similarity classifier 140 and the targeted campaign classifier 150 cooperate in the email campaign detector 130 to provide an early warning system to predict a sustained and malicious email campaign by analyzing, for example, a type of action taken by the autonomous response on a set of emails with similar overlapping features. The early warning system in the email campaign detector 130 is configured to predict a sustained, email campaign of actually malicious emails by analyzing the type of action taken by the autonomous response on a set of emails with many overlapping features, and factoring in a pattern of email analysis occurring across a fleet of two or more cyber security appliances deployed and protecting email systems to detect trends. The “early warning” system can be a fleetwide approach that tries to detect trends across all of our deployed cyber security appliances, with the individual email campaign detector 130 in the local cyber security appliance trying to do so on a per cyber security appliance basis. The email campaign detector 130 can detect campaigns early, before they are written about; and thus, generate reports to the end user about a new email campaign.

One or more machine learning models 160A-160C communicatively couple to the email campaign detector 130 (e.g., See FIG. 1B). The one or more machine learning models 160A-160C are configured to analyze the emails under analysis and then output results to detect malicious emails. (See, for example, FIGS. 3A-3B of example machine learning analysis and the results) The email campaign detector 130 is configured to cooperate with the one or more machine learning models 160A-160C to identify emails that are deemed malicious. The existing framework of cyber threat detection via the modules and models and autonomous response via the autonomous response module 135 to mitigate the detected threat in the email domain is extremely good at successfully identifying and reacting to malicious emails. Autonomous action responses are decided on an email-by-email basis and include, for example, holding a message for further investigation, sending it to the junk folder, disabling hyperlinks, etc. before delivery to the destination inbox. The email campaign detector 130 can provide an early warning system to predict sustained and malicious email campaigns by examining indicators that early on indicate a sustained campaign of bad emails are going to come through by looking at how the autonomous response feature in the email itself is behaving. Again, the autonomous response module 135 to configured to cause one or more autonomous actions to be taken to mitigate malicious emails detected by the one or more machine learning models 160A-160D when a threat risk parameter from a cyber-threat analyst module cooperating with the one or more machine learning models 160A-160D and the assessment module is equal to or above an actionable threshold.

The email campaign detector 130 and autonomous response module 135 can cooperate to analyze what level of autonomous action is initiated by the autonomous response module 135 to mitigate emails in the cluster of emails with similar characteristics compared to a historical norm of autonomous actions to past groups of clusters of emails with similar characteristics. The comparison is made and when different and more severe than the historical norm, then the email campaign detector 130 can consider the different and more severe autonomous action taken on the cluster of emails as a factor indicating that the targeted campaign of malicious emails is underway. The email campaign detector 130 uses both statistical approaches and machine learning. The email campaign detector 130 also tracks and compares the historical data. The email campaign detector 130 has the machine learning aspect to fit and create sensible bounds of what we would expect to see within each of these periods. The email campaign detector 130 can look at the mean and medium as well as machine learning modeled normal pattern of behavior as bound indicators of whether there is a campaign and how serious the campaign is.

The email campaign detector 130 can look at time periods within a given time frame to detect pretty quickly whether this email network being protected is getting a campaign of emails building up and occurring, by looking at and comparing to the machine learning averages as well as the mathematical means and median values, etc. to the current numbers. The email campaign detector 130 can detect, for example, an uptick in more severe autonomous responses and that is indicative of building up to an ongoing email attack campaign. The uptick in severity of the autonomous responses that the autonomous response module 135 takes is more severe than what the system normally and/or historically sees in this organization's email domain. The malicious actor conducting the ongoing email attack campaign generally sends test bad emails to figure out what defenses and vulnerabilities the organization's email domain has before the full en-masse sending of emails occurs.

The email campaign detector 130 has a user interface to allow a user to select a time frame to use for analysis as well as provide default time frames. The email campaign detector 130 examines both the longer time frame as well as individual time periods within that longer time frame. The example time frame may be 8 hours and selected example shorter time periods within that 8 hour time frame may be, for example, over 20 minutes, 30 minutes, 60 minutes to look at both the normal rates of autonomous response to detected bad emails and the level of severity of the responses to the emails.

When an ongoing email campaign is predicted and/or actually occurring, then an increase in the level of defense can occur. The level of analysis and level of responses, and more user restrictions will be implemented; and thus, an uptick will be seen in a first short period compared to a subsequent time period, set by the user to combat the ongoing email campaign.

Additional insight can be gained from a subsequent meta-analysis of these responses in the wider context of all observed emails. Sustained increases or decreases in the rates of autonomous responses merit further investigation. For example, increasing rates might indicate a phishing campaign, and reactive responses can then be supplemented with proactive measures much earlier in the campaign.

Detection of these trends is time series based as well as anomalies across the time series. However, secondary checks are in place to filter out email campaigns of spam (which would be considered a false positive) from email campaigns of malicious emails. Both tend to be indicated by a big spike time series wise in receiving emails with similar indices/characteristics/metrics.

Using several algorithms using mathematical probabilistic methods, the email mail campaign detector can model the normal pattern of response using the history of a given deployment. These methods include, among others, moving averages, means and medians, quantile regression, and bootstrapping to determine confidence bounds for normal rates of response for several periods (e.g., 20, 30, 60 minutes), and a Poisson distribution is also fitted to the same data. Thus, the email campaign detector 130 can look at a number of, for example, one-hour time interval periods within an 8 hour period of a time frame.

Considering multiple periods means that acute changes can be considered in the context of a bigger picture, and longer term trends are not so affected by noise. A time-series of response data for each period is then compared to the system's approximation of normal behavior for that deployment using ranking statistics, binomial and log-linear modeling to calculate severity scores.

The email campaign detector 130 considers how many actions it would totally expect to see within each of the sub periods within the time frame and consider how they rank compared to historical records. The email campaign detector 130 can derive an average and a median run for that sub period (e.g., hour) and then the email campaign detector 130 can compare that across the example 8 hour time frame. As discussed above, the email campaign detector 130 determines ranks for each sub period (e.g., hour), then on top of that the email campaign detector 130 can fit a binomial and test at different levels. The email campaign detector 130 can also do different statistical modeling with bounds of actions. The email campaign detector 130 can test what is the chance of this occurring via how many breaches of the upper bound of actions that it would expect over that sub period and over that time frame. The email campaign detector 130 can also use Poisson distribution to model, for example, half hour intervals and look at activity rates.

The email campaign detector 130 can check and if merely one sub period shows a spike that email activity is not occurring on a sustained basis, then the email campaign detector 130 would say that that was just a spike rather than a campaign. The email campaign detector 130 is looking for not just a single spike but rather a sustained uptick, for example, several periods within that time frame. The email campaign detector 130 is looking for an aggregation of at least 2 or more of those sub periods that have the same model breach pattern or a similar model breach pattern which has to be occurring within the overall time period. The email campaign detector 130 combines this with are these emails deemed malicious for other reasons than merely being sent in the same time frame.

Finally, severity scores can be adjusted because extensive training has shown that deployments of the email campaign detector 130 with sparser autonomous action responses can become overzealous. This severity score allows the email mail campaign detector to better react to changing deployment environments, and to be proactive in certain situations, for example, by to alerting a security operations center to phishing campaigns. The communication module can cooperate with the email campaign detector 130 to generate a notice communicated to a human that the targeted campaign of malicious emails is occurring either as an alert message and/or other conveyance on a display screen. The notice is generated when the email campaign detector 130 determines that the targeted campaign of malicious emails is occurring, via, for example, when the sustained uptick in the clustered emails with similar characteristics that are deemed malicious is detected for two or more time periods within the analyzed window of time for the time frame.

The campaign detector itself is looking for basically lots of similar emails. The email similarity classifier 140 cooperates with the one or more mathematical models in order to compare an incoming email, based on a semantic similarity of multiple aspects of the email, such as headers, subject, body, links, attachments, content, language-usage, subjects, sentence construction, etc., to a cluster of different metrics to derive a similarity score between an email under analysis and the cluster of different metrics.

A communication module of the email campaign detector 130 is also configured to encrypt and securely communicate information from the email campaign detector 130 over a network with a centralized fleet aggregator 305 (external to the cyber security appliance) that is configured to cooperate with a database to collate metrics. The centralized fleet aggregator 305 is further configured to analyze the metrics to detect trends of one or more targeted campaigns of malicious emails occurring in a fleet of instances of the cyber security appliances, and then send the trend data back to the fleet of instances of the cyber security appliance in an actionable way. The email campaign detector 130 can consider a fleet wide shift in behavior that is not tied to a list of known-bad or a set of keywords or bad actors—a more nuanced approach that takes into account a slow shift can produce better results. The email campaign detector 130 is trying to detect shifts in behavior of received emails that may represent some kind of campaign (e.g., organized as an assault on the business or fleetwide trends that indicate changes in the behavior of malicious actors in these campaigns. The centralized fleet aggregator 305 can use a tracker mechanism to track each email campaign of malicious emails, indicate a start of each email campaign of malicious emails, and a sub-mechanism to indicate an end of each email campaign of malicious emails. The centralized fleet aggregator 305 performs a fleet-wide ingestion of the output of AI models and the individual assessments of each email campaign detector 130 in a deployed cyber security appliance that can collate metrics and detect these trends, and then send that in an actionable way. The centralized fleet aggregator 305 sits on top of email campaign detectors 130 in the deployed cyber security appliances and tries to decide when there are trends, and then turn that information about trends into a detection that is pushed back down to all of the email campaign detectors 130.

In an example, when the email campaign detector 130 in a local cyber security appliance detects signs of a campaign attack of malicious emails, then that is reported to the centralized fleet aggregator 305 and the centralized fleet aggregator 305 can see that spreading across two or more cyber security appliances in the fleet, then the centralized fleet aggregator 305 can send both the spreading information and its characteristics as well as the type of autonomous mitigating action to take against the campaign attack of malicious emails. The centralized fleet aggregator 305 assists to share email campaign data across different companies. The centralized fleet aggregator 305 assists to turn fleet-wide data automatically into detection models that can be shared across the fleet, without human interaction.

A Secondary Analysis on the Machine Learning Analysis

The email campaign detector 130 can utilize results produced by machine learning from the one or more machine learning models 160A-160C on aspects of emails, including risk scoring, initially that can be ingested by the email campaign detector 130 and then one or more secondary analyses (normally a mathematical function and/or graphing) are applied to the results produced by machine learning. A significant amount of the material being analyzed is dependent on the output from the machine learning models 160A modelling of a pattern of life analysis and other AI classifier and/or AI model 160B-160C breaches. The email campaign detector 130 can utilize results produced by machine learning on aspects of emails to perform a secondary analysis/meta data analysis/modelling approach, which inherits the machine learning's high fidelity detection of an email that is malicious. The email campaign detector 130 is configured to ingest the output results coming from machine learning out of the one or more machine learning models 160A-160C and perform a secondary analysis on the output results coming from machine learning to refine classifications such as 1) an email, under analysis, is malicious or not malicious, 2) is part of the targeted campaign of malicious emails or should not be included, 3) etc., and 4) any combination of these, by performing at least one of i) a mathematical operation and ii) a graphing operation as the secondary analysis on the output results coming from the machine learning. These secondary analysis of the machine learning results can find outlier emails compared to the rest of the emails that have been put into the same cluster but should not be included in the same email campaign and/or emails that might share similar indices because other indicators observed in the machine learning show the outlier emails differ from the malicious nature of the rest of the emails that have been put into the same cluster. The mathematical operation and ii) a graphing operation performed on the output results by a scripted algorithm takes far fewer computations and memory space than implementing another AI model and/or AI classifier.

Referring to FIG. 1C, the cyber security appliance 100 can have an email module 120 that has a vip determination module 190 and a user importance scoring module 195 cooperating with one or more machine learning models 160A-160D.

A User Importance Metric for Email to Assign a Score Per Internal User

The user importance scoring module 195, in cooperation with the AI models 160A-160C, is configured to assign a score (metric) to each internal user, reflecting their importance based on their email flow within the organization. The scores are continuously updated, using windows of time, such as 24 hours or three weeks, to account for variations in email flow. This real-time, continuous classification of all users ensures that changes in user status, such as a VIP leaving the organization or a user becoming “briefly important,” are quickly and promptly reflected in the refreshed importance scores.

The user importance scoring module 195 is configured to operate on the assumption that high-profile individuals are more likely to be targeted by external actors. As such, the statistical analysis employed by the user importance scoring module 195 considers users who receive a high volume of unsolicited, targeted external emails as being important. The score can be calculated for a user irrespective of whether the incoming external emails are benign or malicious (an example of malicious emails is phishing emails), although as will be explained in further detail below, being targeted by malicious emails can further boost the importance score of a user.

The email behavior of a user is factored into the score because the email behavior can be indicative of the role of the user within the organization. For example, a user's importance score may be reduced if the user frequently replies to external emails or emails from free mail domains (e.g., personal email addresses) because these behaviors are more likely associated with customer-facing roles or human resources (HR)/recruitment roles, rather than senior positions. When calculating the importance score, the user importance scoring module 195 may not examine the exact content of the emails, making the importance score language agnostic. It can look at volume and replies as a standalone metric or as a factor in determining the user's importance.

In particular, the user importance scoring module 195 is configured to identify new inbound senders based on inbound emails into the email module 120. Each user of the email system of the organization is given by the user importance scoring module 195 an initial importance score that corresponds to the likelihood of receiving inbound emails from new external senders (e.g., the total number of inbound emails from the new external senders communicating with the organization via email for the first time over a predefined period of time in the immediate or recent past, where the user is the recipient or one of the recipients). In some embodiments, the inbound email volume and the number of replies can be used as a standalone metrics in determining the importance score of a user. In some embodiments, the inbound email volume and the number of replies can be used as one of the factors in determining the importance score of a user.

In one embodiment, the user importance scoring module 195 is configured to increase the importance score of a user based on the quantity of emails targeted at just the user or a small number of users (as opposed to emails targeted at a large number of users, where a predefined threshold can be utilized to determine whether an email is targeted at a small number of users). The more the emails targeted at just the user or a small number of users, the more the importance score is increased for the user. This is so that emails such as newsletters that are targeted at a large number of users/recipients do not unduly increase the importance scores for users receiving such emails. In one embodiment, the user importance scoring module 195 is configured to increase the importance score of a user based on emails targeted at the users being deemed malicious (e.g., by the assessment module in cooperation with machine learning models 160A-160D). The more an email is deemed malicious, the more the importance score is increased for the user. Further, the more the emails deemed malicious, the more the importance score is increased for the user. Increasing the importance score for a user based on malicious emails targeted at the user is based on the assumption that more important users are more likely to be targeted by malicious actors more frequently and with more sophistication.

The user importance scoring module 195 is configured to adjust the importance scores for users based on one or more dampening factors. Each dampening factor can be associated with a dampening value (e.g., a value between 0-1) that can be used as a discount value (which can be applied to the importance score by multiplying the importance score with the dampening value) to reduce the importance score of a user by an appropriate factor. In one embodiment, according to one dampening factor, the user importance scoring module 195 is configured to reduce the importance score of a user based on the frequency of the user sending outbound email communication to new external senders (or replying to inbound external email correspondences). The more/the more often a user sends outbound email communication to new external senders, the more the importance score for the user is reduced. This dampening factor is based on the assumption that more important persons are less likely to respond to cold calls. This dampening factor helps to differentiate between high-importance users and those who are simply active in email communication.

In one embodiment, according to one dampening factor, the user importance scoring module 195 is configured to reduce the importance score of a user when the user sends high frequency outbound emails with regularity. The more often a user sends high frequency outbound emails, the more the importance factor for the user is reduced. This dampening factor is based on the assumption that users that send high frequency outbound emails with regularity may be automated email addresses that receive and send high volumes of emails. In one embodiment, according to one dampening factor, the user importance scoring module 195 is configured to reduce the importance score of a user when the user sends no or few outbound emails in a time period in the recent or immediate past. This dampening factor is based on the assumption that a user that sends few outbound emails may have left the organization or otherwise no longer exist within the organization.

In one embodiment, according to one dampening factor, the user importance scoring module 195 is configured to reduce the importance score of a user when the user regularly engages in email communications with email addresses hosted at free email domains (e.g., personal email addresses). The more/the more often the user sends and/or receives emails to/from email addresses hosted at free email domains, the more the importance score for the user is reduced. This dampening factor is based on the consideration that high frequency communication with email addresses hosted at free email domains may indicate that the user is in a customer service or HR/recruitment role with high contact in both directions, and thus not a high-importance user.

In one embodiment, according to one dampening factor, the user importance scoring module 195 is configured to reduce the importance score of a user when the user is rarely copied on email threads with external participants by colleagues (i.e., other users of the email system of the organization). The more infrequent a user is copied on such email threads by colleagues, the more the importance score for the user is reduced. This dampening factor is based on the consideration that infrequency of being copied on such email threads by colleagues may suggest the that the user occupies an isolated public-facing role, and is thus deserving just a reduced importance score.

In one embodiment, according to one dampening factor, the user importance scoring module 195 is configured to reduce the importance score of a user when the user is often copied on email threads whose participants do not include other high-importance colleagues. The more/the more often the user is copied on such email threads, the more the importance score for the user is reduced. A colleague is considered a high-importance colleague if the importance score of the colleague is greater than a threshold amount. In one embodiment, whether a colleague is a high-importance colleague can be evaluated based on the importance score of the colleague without dampening factor adjustments. In one embodiment, whether a colleague is a high-importance colleague can be evaluated based on the final importance score of the colleague with the dampening factors having been applied.

The importance scores for all users can be periodically recomputed (i.e., refreshed/updated) by the user importance scoring module 195. By way of non-limiting examples, the importance scores can be recomputed every 24 hours, every three weeks, and so on. As such, the real-time, continuous classification of all users ensures that changes in user status, such as a vip user leaving the organization or a user becoming “briefly important,” are quickly and promptly reflected in the refreshed importance scores.

The vip determination module 190 is configured to use the importance scores computed by the user importance scoring module 195 to determine whether users are vip users. A user is characterized to be the vip user by the vip determination module 190 if the importance score of the user is greater than a predefined threshold. In one embodiment, the vip determination module 190 is configured to output a list of vip users. In one embodiment, the vip determination module 190 is configured to enable a system administrator to manually confirm or dismiss the vip status of a user. In one embodiment, the vip determination module 190 is configured to identify second-order important users, who are close associates of vip users (as identified based on email communications). The second-order important users are of interest because they can be vectors through which the vip users can be compromised.

The system also allows for the creation of separate custom threat handling rules for vip users versus non-vip users. This allows for less disruptive or intrusive threat handling for the vip users but at the same time closer monitoring and/or deeper analysis with higher priority to identify malicious activities against the vip users, based on the consideration that the risk of harm is greater when a vip user is compromised as opposed to a non-vip user. Where second-order important users are identified, the closer monitoring and/or deeper analysis can be applied to the second-order important users as well. In one embodiment, the importance scores can be exported to other subsystems or other areas of the system to enable them to optimize their operations based on the information about user importance. For example, a threat score may be increased if something unusual is detected on a vip user as opposed to a non-vip user. In another non-limiting example, the user importance scores can be used by the impersonation detector 180 to detect if an email is sent by an impersonator trying to impersonate a user in the organization. In particular, the more important a user is, the more likely the user is to be impersonated. Therefore, if the sender of an email has a name that is similar to a vip user, the impersonation detector 180 can determine that it is likely that the email is sent by an impersonator. On the other hand, if the sender of an email has a name that is very similar to a non-vip user, the impersonation detector 180 can assume that the similarity in the names is likely to be coincidental.

Accordingly, the system is designed to minimize disruption and tailor actions and action severity towards key stakeholders (e.g., vip users). The system does not require significant manual tuning, making it suitable for large organizations. The system intelligently derives the user importance information, rather than relying on simplistic hard-coding or rigid conceptions of seniority linked to organization charts or job titles. This allows the system to identify the larger subset of important users that may exist in an organization, not just those the system administrators may consider important.

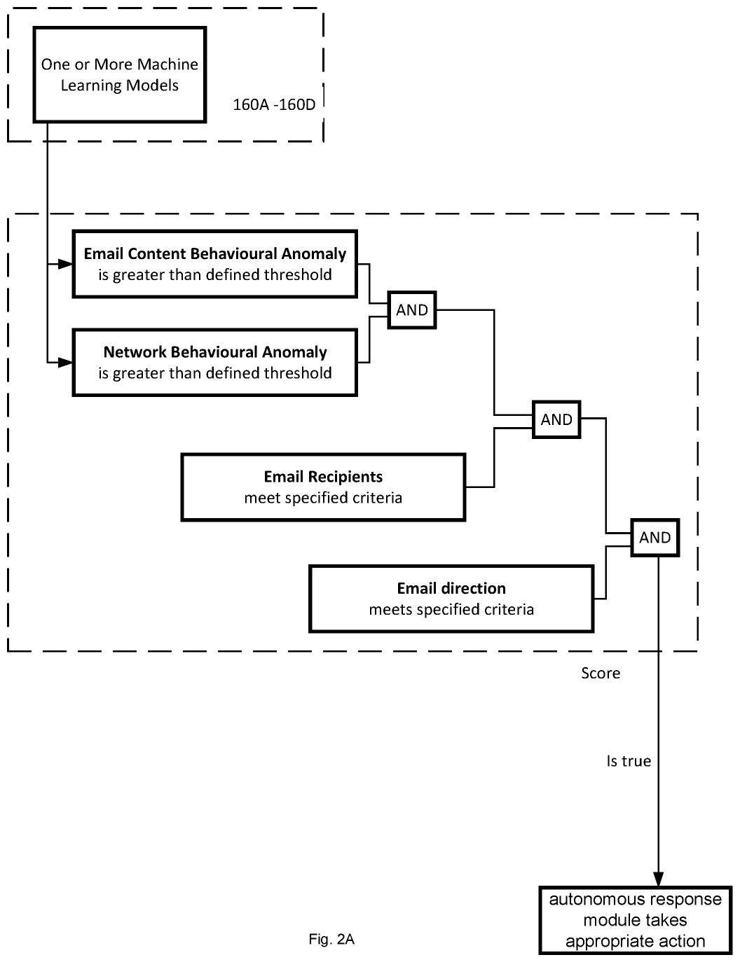

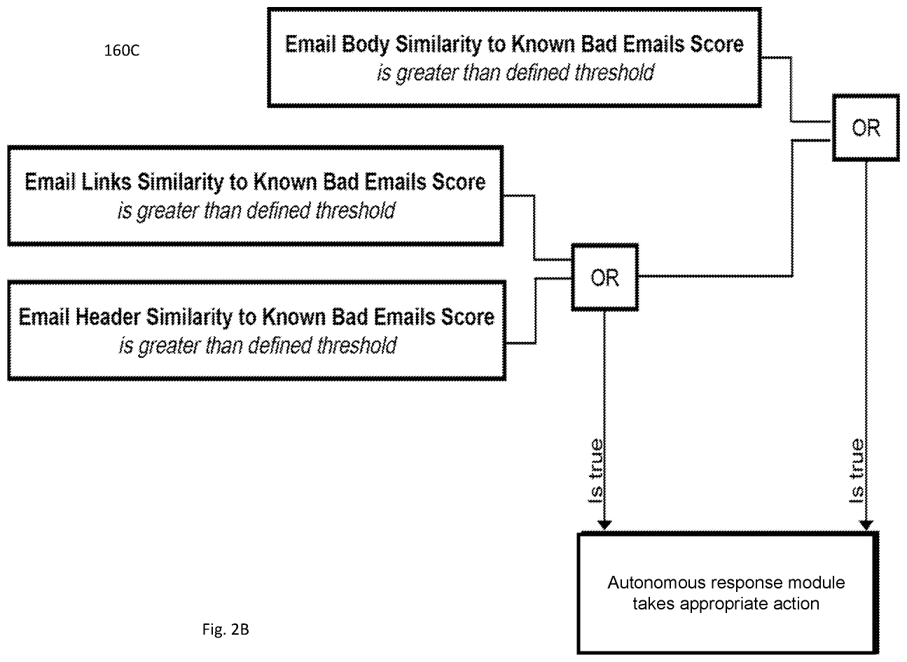

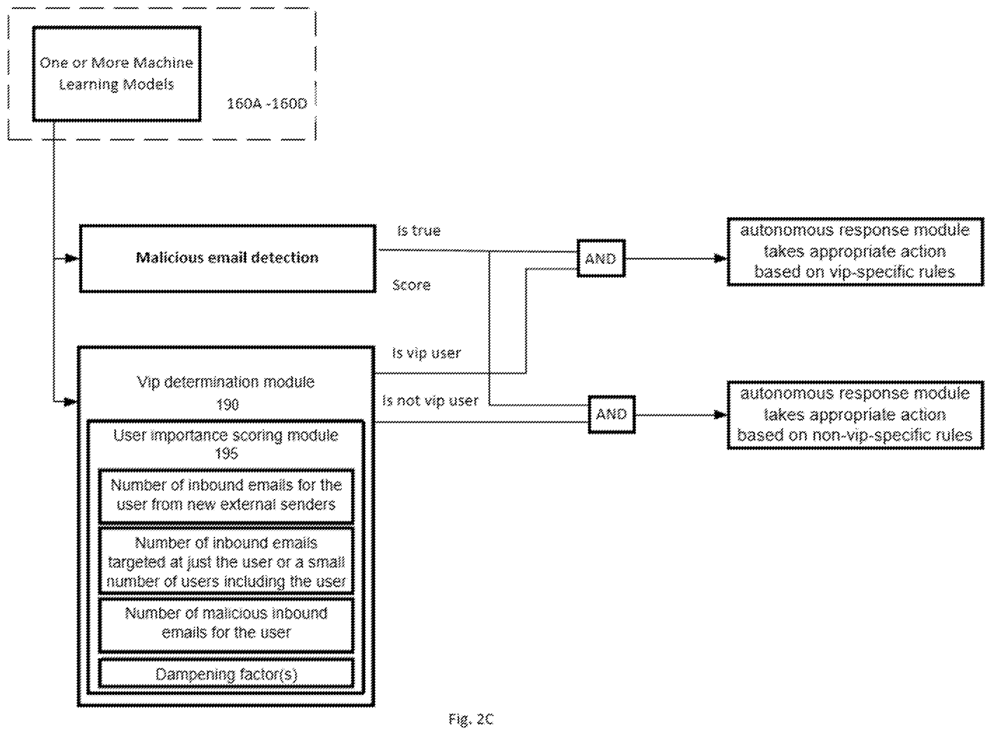

FIGS. 2A and 2B illustrate flow diagrams that show examples of machine learning analysis. FIG. 2B shows multiple example comparisons and decisions/output results made at each stage by the machine learning for an email similarity scoring when comparing an incoming email. This example is based on a semantic similarity of multiple aspects of the email to a cluster of different metrics derived from known bad emails to derive a similarity score between an email under analysis and the cluster of different metrics derived from known bad emails. Is the e-mail's body similarly compared to a known bad emails score greater than that defined threshold? Is the email's links similarity to known bad e-mail scores greater than the defined threshold? Is the email's header similarity to known bad e-mail scores greater than the defined threshold?

FIG. 2A shows multiple example comparisons and decisions/output results made at each stage by the machine learning for determining a nature of an email. Is the e-mail content behavioral anomaly greater than the defined threshold? Is the network behavioral anomaly greater than the defined threshold? Do the e-mail recipients meet specific criteria yes or no? Does the e-mail direction inbound or being sent out meet the specific criteria yes or no? And then, multiple of these decisions can be combined together to make a determination about a nature of an e-mail and produce output results but individually along the way at each node machine learning output results are also being determined for each e-mail that's under analysis.

An Analysis of Mismatched Display-Name and Addr-Spec Fields as an Indicator of Malicious Intent

The email campaign detector 130 has an impersonation detector 180 configured to analyze whether either a nexus exists or just a complete mismatch exists between a display-name and an addr-spec field of an email under analysis as a factor in detecting whether the email under analysis is malicious; and therefore, potentially part of the targeted campaign of similar malicious emails- or just spam email that is regularly received by an email mailbox. As discussed, spam emails and a targeted email campaign of similar malicious emails both are indicated by a large uptick of similar emails destined for the inboxes of an email network occurring in a short time frame. However, email users opening up spam emails are generally subject to merely wasting their time as opposed to a malicious email that subjects the user's email to some sort of cyber attack to obtain their credentials, obtains their personal information, takes control over their computing device, etc.

RFC 5322 & 2822 section 3.4.1. both give an example meaning of an addr-spec field of an email. “An addr-spec is a specific Internet identifier that contains a locally interpreted string followed by the at-sign character (“@”, ASCII value 64) followed by an Internet domain. The locally interpreted string is either a quoted-string or a dot-atom.
addr-spec=local-part “@” domain
local-part=dot-atom/quoted-string/obs-local-part
domain=dot-atom/domain-literal/obs-domain” (RFC 5322, titled Internet Message Format, section 3.4.1)

Thus, in general the addr-spec field indicates, for example, a sender of an email message. Every email address consists of 3 elements: a local-part, @ symbol (pronounced as “at”), and a domain name. The local-part (e.g., locally interpreted string) is placed before the @ symbol, and the domain name is placed after the @ symbol. For example, in the email johndoe@company.com, “johndoe” is the local-part, and “company.com” is the domain.

The email campaign detector 130 can factor a secondary analysis of a mismatched display-name and addr-spec (e.g., email address) fields as an indicator of a malicious intent of an email that likely is part of a malicious email campaign. The impersonation detector 180 can use an algorithm and/or trained AI classifier to make a probability assessment that two strings (personal/display name and email) are linked, where the personal/display name+from address matching is a very high fidelity metric when trying to identify spam or malicious emails. The impersonation detector 180 can use this algorithm and/or AI classifier to detect probabilistically if an email address is trying to impersonate a user/entity. The email campaign detector 130 can better detect troublesome threats such as business email compromise with a mismatched display name to addr-spec field, as well as dropping low-quality spam via the impersonation detector. An AI classifier is trained to spot normalities and abnormalities and/or a mathematical algorithm can be scripted to spot normalities and abnormalities in the display name to addr-spec field as discussed herein.

Unsophisticated malicious email campaigns will often use a seemingly human display-name, with a randomly generated addr-spec. Often the randomly generated addr-spec can result in a totally non-human readable/gibberish email address. For example, a human display-name of “John Smith” from the example email address “dfigbhrep8gyrgri@gmail.com” of an email. Some complete mismatches will be straightforward to identify, e.g., a human display-name of “John Smith” from the example email address “dfigbhrep8gyrgri@gmail.com. Thus, the impersonation detector 180 determines rather quickly that no nexus exists and that it is just a complete mismatch between the display-name and an addr-spec field of the email under analysis. When it is a gibberish name that does not make much sense to a human, then that is probably malicious.

A mismatch of a display-name to addr-spec does not surely indicate malicious intent; many addr-specs are innocently unrelated to their sender's name, e.g., “Tony Laws sunderlandfan73@hotmail.com”. However, if an email is suspicious in another respect (e.g., it has been assigned a moderately high phishing inducement score by another AI classifier and/or AI model breach) the context renders the potentially innocent mismatch between display-name to addr-spec as additional evidence of malicious intent.

Some nexuses will be straightforward to identify, e.g., “john smith john.smith@gmail.com”. Others, such as “smith, john william—company president jwsmitty8955@gmail.com”, require careful consideration of both fields in order to determine whether or not it is reasonable to say that nexus exists such that the display-name matches the addr-spec. John William Smith has the initials JWS which forms part of the addr-spec field; and thus, a possible nexus exists.

The machine learning in the impersonation detector 180 has been trained to distinguish between gibberish to a human and conversely why it would be understandable that somebody would create their name in the addr-spec field that way. Two important aspects to consider are variants of name parts and the treatment of accented characters. For example, the name Robert could be used in the display-name and Bobby in the addr-spec. Diacritical marks, such as ü are not widely used in addr-specs and may have more than one transliteration. Taking the surname Müller as an example, it is important to consider the form Muller with no diaresis, as well as the alternative transliteration of Mueller. Thus, extensive lists/tables of common variants (e.g., Robert/Roberto/Bobby/Robby/Rob/Bob/R and last name/B and last name) that semantically to a human could be interpreted as a reasonable nexus to a human can be created and referenced. The email campaign detector 130 can use a suite of mappings and algorithms to extract a basic form of names from the display-name and addr-spec fields. Comparing these extractions with carefully selected abbreviations, concatenations, and permutations of observed “words” either increases or decreases our confidence that an email is spoofed; and thus, a malicious email.

The impersonation detector 180 can use various example algorithms as follow.

Spoof Detection—Name Spoof Detection

Canonical Name—A part of name spoof detection is the extraction of ‘the canonical name’. The canonical name can be an estimate of the sender's name in an example format such as ‘firstname_lastname’ from a given personal or email field. In this example, the first and last names are also taken to lower case and have letters deduped. E.g. if the impersonation detector 180 extracts the first name “Allison”, the impersonation detector 180 would also have the canonical first name “alison”. However, canonical names can contain additional information the impersonation detector 180 attempts to see through, such as titles, middle names and job roles. For example, given the personal ‘Ms Poppy Susan Gust—Darkhorse Chief Executive Officer (CEO)’, the algorithms in the impersonation detector 180 aim to extract, for example, ‘popy_gust’.

Known Name—In order to identify which inbound emails that are spoofs, the impersonation detector 180 needs candidates to check against (candidates are potentially known names/addresses of the recipient that a malicious actor may be attempting to impersonate). Known contacts are added when an internal email user messages (including replies) to an address. Canonical names are derived from both the derived personal and email fields of the sender/recipient. The impersonation detector 180 temporarily notes the personal fields of external addresses when the impersonation detector 180 sees them, so the impersonation detector 180 can also mark the canonical associate with that name/email address as known.

Skeletonning Parts—Malicious spoofing emails can attempt to obfuscate their spoofing target in some way to confuse simple name matching. For example, “St3ρhεπ M!cKmαπ” could be seen as an obfuscated “Stephen Mickman” in a more extreme example. Therefore, the impersonation detector 180 created a function which maps a given input string to a ‘skeleton’ form of the string (in the given example mapping “St3ρhεπ P1cKmαπ” to “Stephen Mickman”). When the impersonation detector 180 considers matching parts of incoming names to our known names, the impersonation detector 180 considers both the raw and skeleton forms of the name.

Freq Estimations—When detailing spoof scoring, the impersonation detector 180 relies on estimates of the commonality of name parts. The commonalty can be determined by statistics (i.e., a posterior Bayesian probability). As the impersonation detector 180 will also consider initial matching, the impersonation detector 180 estimates freqs for initials based on the number of times the impersonation detector 180 sees a first letter of a name over the total number of names.

Spoof Matching—The impersonation detector 180 can consider matches between an incoming name and all known contacts. However, the impersonation detector 180 can also identify ‘spoof candidates’ as a small subset of the known contacts which could potentially be being spoofed: 1. Extract the canonical form of the incoming name. 2. Compute name variants. There are two types of variants to consider. The first, considering potential forename replacements such as Billy for William, or Steve for Stephen. Second, the different handlings of nobiliariary name parts, such as ‘van’, ‘von’, ‘de’, ‘da’ etc. For example, the impersonation detector 180 could see the Dutch surname “van der Sarr” represented as the single word “vandersarr” (especially true in email addresses). 3. Identify candidate known contacts. These are known contacts where the canonical form of the associated name has at least one part match a part/name variant of the incoming name. For example, the known contact “Lee Stanley Cattermole” with canonical “le_catermole” would be a candidate of the incoming potential spoof “Bruce Lee” with canonical “bruce_le”. This is due to both containing the same canonical part “le” part. The impersonation detector 180 considers matching on both the raw and skeleton parts of the incoming canonical name. 4. For each candidate canonical, see if each part of the canonical can be matched to a part of the incoming name. The parts of the incoming name do not need to form part of the canonical to match, though each part of the match can only match one part of the candidate canonical. For example, known contact “Bruce Stanley Lee” can still match “John Bruce Lee”, despite the respective canonicals of “bruce_le” and “john_le”. The matching considers: a. Exact match (e.g., known part “stephen” to candidate part “stephen”). b. Skeleton match (e.g., known part “stephen” to candidate part “St3ρhεπ”). c. Name variant match (e.g., known part “stephen” to candidate part “steve”). d. Substring match (e.g., known part “stephen” to candidate part “ste”). Minimum substring length applies to prevent false positives. e. Initial match, only if either the candidate or incoming part already is an initial. For example, with Stephen Mickman the impersonation detector 180 would consider an initial match for “s” in the incoming name “s Mickman” but not for “Samuel Mickman.” If all parts of the known name are matched to the parts of the incoming name, the incoming name is marked as a spoof of the known name, and a spoof score is calculated.

Spoof Scoring—Once a spoof match has been detected it is assigned a spoof score between, for example, 0 and 100 (from weakest to strongest) indicating the impersonation detector's confidence that the match is due to malicious spoofing intent, rather than coincidence. A spoof score can include a prior spoof probability before the impersonation detector 180 does any spoof matching. The impersonation detector 180 also uses a smaller prior probability for high exposure candidates. The impersonation detector 180 determines a probability of the name matching by chance, which can factor in the freqs of the incoming name part. The posterior spoof probability is then calculated. The impersonation detector 180 can use score capping on different variables be evaluated in the posterior spoof probability. Sometimes the impersonation detector 180 match names with the same first and last name, but have other unmatched parts (e.g., a middle name and/or initial) and caps based on its knowledge of the real person's middle name. Note, the impersonation detector 180 can also factor in that the name being match may come in in reverse order. The impersonation detector 180 also factors when the name is understandable to a human, but part of the name match appears to be not normally a last name or first name associated with a human (e.g., “IT Helpdesk”).

Domain Spoof Matching in Name Spoof Detection—The impersonation detector 180 factor in some domain matching on the personal name field. For example, a skeleton of an incoming name part could match the skeleton of a known domain.

Domain Matching—the impersonation detector 180 can store known domains and/or vectorize them at the bigram level. The impersonation detector 180 can perform mathematical operations to improve the efficiency of checking the similarity between the incoming domain and all known domains efficiently. In name spoof scoring the impersonation detector 180 detailed how skeletons are used to detect matches when the incoming spoof is maliciously obfuscated. Skeletons are again considered in domain spoof matching, as well as the raw string of the domain.

Name in Personal Checking—The impersonation detector 180 can process iterating through pairs of ordered personal parts and checking against a single email part as follows:

1. Get a next ordered pair of ordered permutations of personal parts. 2. Perform Check Concatenated Canonical. If a match is found return True, else go to step 3. 3. Perform Check Both Parts Contained. If a match is found return True, else go to step 4. 4. Perform Check Initial Plus Surname. If a match is found return True, else go to step 5. 5. Perform Check Forename Plus Initial. If a match is found return True, else go to step 6. 6. Perform Check for Initial Plus×Plus Surname. If a match is found return True, else go to step 7. 7. Perform Check for Forename Plus×Plus Surname. If a match is found return True, else go to step 8. 8. Perform Check Name Variants. If a match is found return True, else go to step 8. 9. If all ordered pairs of ordered permutations have been checked go to step 10. Else go back to step 1. 10. Perform Initialization check. If a match is found return True, else return a False. A similar process would be used on a full name in the Personal Algorithm.

This method shows success in identifying links between mismatched display-name and addr-spec fields, and thereby, identifying potentially false classifications based on literal matching alone. Mismatched display-name and addr-spec fields can be an indicator of spoofing when a semantically logical nexus cannot be established. However, a semantically mismatched display-name and addr-spec fields with a logical nexus can rebut this indication of spoofing. The email campaign detector 130 can further analyze the human display-name from an email compared to both the addr-spec field and the email address associated with that email under analysis to assess whether the display name and the addr-spec field email are linked. Thus, a semantically mismatched display-name and addr-spec fields, especially when tied to email domains associated with personal email addresses, such as @gmail.com, @yahoo.com, etc. (as opposed to a business email address domain such as @darktrace.com) lessens the chance that this not-literal matching but at least a semantic nexus from display name field compared to addr-spec field is not an indicator of malicious intent. Whilst accurately identifying such mismatches in itself is not a sure sign of malicious intent, mismatched display-name and addr-spec fields can be used alongside other metrics that indicate some elements of malicious intent. This in turn means the email campaign detector 130 can refine its response to emails when required, leading to better protection and mitigating overreactions accordingly.

Note, a totally non-human readable email address with a name of somebody that is in the company is probably a bad thing the vast majority of the time. However, when a person goes by Bill and the email addresses William or W(insert last name), then this is not a bad thing. Also, when the name in the addr-spec field has some sort of Cyrillic script or some other non-Latin alphabet characters inserted within Latin alphabet characters to disguise stuff, then this is a factor to consider in determining whether this is a spoof.

Also, the impersonation detector 180 can use a predefined list of normal like very obvious contractions, abbreviations, concatenations, and permutations that people will use, and so we use these abbreviations, concatenations, permutations, and to increase the impersonation detector's confidence or decrease the confidence that the email is spoofed.

Note, an email address is a much more fixed entity compared to the display name which the user can edit in an email client and alter the display name to play around with it. The user can change their display name all the time but it is still coupled to the same email address portion. The cyber attacker is constantly changing display names according to the victim they are trying to fool.

This impersonation detector 180 is very useful in catching when the display name appears to have no relation to the email address and/or the same email address has a history of multiple different display names across different emails with little to no relationship between the display name and the email address. The impersonation detector 180 also has exclusions for things that do not actually look like that part of the name—title e.g., CEO, Dr., Mr., Ms., etc.

A Real-Time, Self-Correcting Similarity Classifier for Emails

The email similarity classifier 140 can be configured to analyze the group of emails based on a set of multiple similar indices for the clustered emails with similar characteristics. The email similarity classifier 140 can be configured to cooperate with a self-correcting similarity classifier 170. The self-correcting similarity classifier 170 is configured to apply at least one of i) a mathematical function and ii) a graphing operation to identify outlier emails from the cluster and then remove the outlier emails from the cluster; and thus, from the targeted campaign of malicious emails, based on a variation in the output results generated by the machine learning models 160A-160C for the outlier emails compared to a remainder of the emails in the cluster of emails with similar characteristics, even though the outlier emails shared similar characteristics with the remainder of the emails in the cluster of emails with similar characteristics.

The email campaign detector 130 can use a real-time, self-correcting similarity classifier 170 for emails as a factor in detecting whether an email is malicious; and therefore, potentially part of a campaign of malicious email, or not malicious and probably a spam email.

The email campaign detector 130 that uses a real-time, self-correcting similarity classifier 170 on a set of multiple similar indices for emails, and therefore clustered together, is configured to remove outlier emails from the cluster (and thus the suspected email campaign) based on the variation in, for example, the threat score produced by the machine learning analysis and/or autonomous action taken on the clustered emails. Note, the self-correction mechanism can correct both at the individual client and fleet-wide levels. The self-correcting similarity classifier 170 derives classifications from a secondary analysis derived from mathematical operations and/or graphing operations on the output results coming from the machine learning.

Again, an email campaign detector 130 working in a corporate environment might try to cluster inbound emails that have similar metrics, are deemed malicious, and, for example, are sent from the same person, group, or entity (thus a “target campaigns of emails”).

However, similarity classification can be a non-trivial problem given that, in the context of phishing, for example, emails may be sent from addresses that subtly change throughout the campaign. Given the degree of automation in phishing production, a single actor can easily change metrics, such as the email address or subject line with each email in the email campaign. Incidentally, this poses a problem for systems that rely on maintaining lists of known abusive email addresses.

Again, the email campaign detector 130 detects email campaigns by attempting to derive a group of related malicious email communications (where the emails share a number of characteristics/metrics/indices) that may originate from the same threat actor, or share, the same targeted entity (individual person, individual business, same industry) across globally or locally geographically.

The email campaign detector 130 tracks a wide range of indices that include three or more indices such as the from header, the subject line, the URLs, the attachments in the emails, the links in the emails, the length and format of the body of the email, etc. When an email arrives, the email similarity classifier 140 checks these indices for similarities to other recent emails-adding the email to an existing cluster or forming a new cluster if it considers the email similar to another email that does not already belong to a cluster. The email similarity classifier 140 detector does not assume any single metric within the tracked set of indices will remain fixed during a campaign, and so the system also tolerates a degree of fuzziness. The email similarity classifier 140 detector creates, for example, a set of three or more similar indices/metrics that are tracked, and thus, individual indices/metrics within that set can vary and be different than other instances of those indices in another email but yet are still deemed similar because at least two of the indices match up in the set of three or more indices. Thus, all these email addresses, all these links, all these subject lines, etc., and they can all be very different, and yet the email similarity classifier 140 can have the confidence to say it still constitutes a single campaign because it saw enough similarities in the composite set of tracked indices. The email similarity classifier 140 saw these different characteristics change one by one, but always maintaining some similarity to the entire campaign.

However, there is an additional problem that some emails may have coincidental similarities. If a coincidental similarity is established between one email and several others, and then further coincidental similarities are established between these emails and new arrivals, it is possible that a runaway effect quickly clusters a large number of emails that do not constitute a real email campaign of malicious emails. The email similarity classifier 140 itself is looking for basically lots of similar emails but a problem with this is a situation might exist where a bunch of emails look similar but in fact are not similar.

The self-correcting similarity classifier 170 provides a mechanism for self-correction to detect coincidental similarities and remove non-malicious emails from the email campaign of malicious emails. Rather than solving the problem by tracking ever finer criteria, the self-correcting similarity classifier 170 adds a mechanism for self-correction that solves the problem of coincidental similarity by detecting a fluctuation in sequences of results from the machine learning analysis of this same bunch of emails that look similar. The results from the machine learning analysis typically include some sort of score/numeric value computed for a different purpose elsewhere in the system. The self-correcting similarity classifier 170 can use the hypothesis that emails sent by the same actor with the same intent will be marked and given a score/numeric value by the machine learning analysis in the cyber security appliance anomaly-detection system in a predictable way.

The self-correcting similarity classifier 170 hypothesizes that the chronological sequence of these anomaly scores would exhibit smoothness if the emails were indeed from the same actor. By contrast, if the email similarity classifier 140 clusters emails that are in fact unrelated, the real-time sequence of anomaly scores would be far more likely to exhibit an unpredictable fluctuation.

Test data shows this hypothesis to be correct and so the email campaign detector 130 has a self-correcting similarity classifier 170 to compute a measure of fluctuation in a score/numeric value produced by the machine learning analysis in real time. If the measure exceeds a certain threshold, the similarity classifier stops clustering and removes the cluster's status as a campaign. When the measure exceeds a certain threshold, the self-correcting similarity classifier 170 can remove outlier emails from the campaign.

The self-correcting similarity classifier 170 makes an assumption if these emails that were all clustered together as part of a same email campaign because of the detected similarities between are intentionally crafted emails to be malicious, then the autonomous response module 135 should take approximately the same autonomous actions to mitigate those malicious emails. Thus, the self-correcting similarity classifier 170 can look at the similarity of the autonomous action responses and inductively how much the machine learning considered this cluster of emails truly as malicious. This can be graphed to see if it is a smooth curve for this cluster of emails. However, if an autonomous action response to one or more emails in the cluster of similar emails is quite different, then that outlier email in the cluster of similar emails thought to all be in a same email campaign is considered to coincidentally share similarities and its data is removed from the analysis of the AI analysis. Additionally, if the formed cluster consistently has the outlier emails removed, then the status of the formed cluster is disbanded as this is no longer considered a cluster of malicious emails. The detected outlier can be checked out to verify the quality of the analogous and then back to the self-correcting similarity classifier 170 as training.

Imitation or Coincidence: Using Bayesian Inference to Analyze Varying Names

The email campaign detector 130 has an impersonation detector 180 configured to use a probabilistic inference, such as a Bayesian inference, to analyze a variation in either a display name or a name in the addr-spec field of an email address compared to a trusted version of that name as a factor in detecting whether an email was generated via spoofing and thus is malicious; and therefore, potentially part of the targeted campaign of malicious email or not malicious and probably a non-malicious email or at most mere spam emails.

The email campaign detector 130 can use a Bayesian inference to analyze varying names as a factor in detecting whether an email is malicious; and therefore, potentially part of a malicious email campaign of similar emails or not malicious and probably a non-malicious email or at most mere spam emails. Bayesian inference is used in mathematical statistics. Bayesian inference can be a method of statistical inference in which Bayes' theorem is used to update the probability for a hypothesis as more evidence or information becomes available. Bayesian updating is particularly important in the dynamic analysis of a sequence of data.

The impersonation detector 180 can use a Bayesian inference to analyze varying names of known senders and/or known recipients of emails to identify a malicious email that was generated via spoofing. The known senders and/or known recipients of emails are a trusted version of that name because historically emails from or to that known sender and/or known recipient were not classified as a malicious email. The mechanism tries to detect probabilistically that a given email is trying to impersonate a known user.

The impersonation detector 180 provides a spoof detection feature by similarity in names in the email. Thus, a name similarity assessment for spoofing detection. When emails contain links, attachments, or a request for payment, recipients are naturally more skeptical if the message comes from an unknown sender. Spoof emails attempt to impersonate senders who are known to and trusted by target recipients to induce them to perform an action they would otherwise be unwilling to do. For example, a spoof email may attempt to impersonate an employee's manager in order to access confidential or sensitive documents, or impersonate a company's supplier in order to receive payment for a fraudulent invoice.

A first step in identifying potentially spoofed emails is to list potential target recipients. The impersonation detector 180 can use a carefully selected set of algorithms to determine whether each of the senders of inbound email and/or recipients of outbound email can be considered “known and thus a trusted version of that name”. These algorithms also consider factors such as domain popularity across multiple deployments (not just the particular deployment) to more readily and reliably identify spoof candidates.

A second step is to consider variations in form from the known trusted version of the name to identify potential spoofs. Spoofers often try to obfuscate their imitation, for example by using non-ASCII characters or subtle variations in spelling to prevent exact text matches (e.g., Matt in place of Matthew; or Danktrace in place of Darktrace).

The impersonation detector 180 can use a suite of mappings and algorithms to extract a basic form of each potentially spoofed name and compare it to incoming display-names to identify potential spoofs. The email campaign detector 130 can use Bayesian inference to refine name-matching scores. With each ‘known name’ registered, the impersonation detector 180 can update the set of prior beliefs about the probability of each name part indicating a spoof, e.g., if we see the name part “John” is it more likely the sender is impersonating a known contact named “John” (or coincidentally, that the sender shares the same name).

These probabilities are then used to calculate a conditional probability of seeing the name as a whole, given that it is not a spoof. This conditional probability and the prior belief can be used to calculate a Bayesian posterior probability of the name in question being a spoof.

In simple terms, if the impersonation detector 180 can match a common name such as “John Smith” and see an incoming email from “Johnny Sm!th”, what is the probability that this incoming email is imitating “John Smith” as opposed to coincidentally sharing a slight variation of the name. This can then be used to refine autonomous actions taken by an autonomous response module 135 as well as be a factor in considering whether an email under analysis is malicious.

An Autonomous Detection of the Intended Function of a Corporate Inbox Through Meta-Scoring

The email campaign detector 130 uses an inbox type detector to tailor its assessment of maliciousness/action threshold to the type of inbox or to the users' behavior. The email campaign detector 130 can use an autonomous detection of the intended function of a corporate inbox through meta-scoring.

The email campaign detector 130 can use one or more algorithms scripted to perform autonomous detection of an intended function of a corporate inbox through meta-scoring (including threat scores) of emails and their intended recipient, and then once the intended function is determined then to adjust an appropriate autonomous action taken to mitigate the detected malicious emails for externally facing/public facing inboxes compared to key email users in an email system. The email campaign detector 130 can try to prevent business disruption by high-fidelity detections that tailor autonomous responses by the autonomous response module 135 based on the type of inbox, how normal it is for the user to receive low-quality external spam, etc.

The email campaign detector 130 personalizes the email protection approach between organizations, between types of mailboxes, etc. In contrast, most other email security systems are attempting to detect known-bad email lists as a blanket detection across all their clients. Interest is also focused on a tailored approach, i.e., one that is unique for each user and their standard pattern of behavior. An email address/account that is published so that the general public sends emails to that email account such as info@abc.com, contact_us@abc.com, customer_support@abc.com (and thus is publicly facing) will have a different threshold for junk or spam mail than one who is not publicly exposed alex.smith@abc.com. This is again how business disruption is prevented when action is taken.

Many corporate inboxes receive large quantities of email from varied and unpredictable external servers. For some inboxes, the email campaign detector 130 factors in that it is both expected and intended because they have public-facing addresses, and most of the mail they receive from external senders is usually characterized by benign intent. For others, such as those belonging to company executives, messages sent by external senders are much more likely to be malicious, irritating, or both. The email campaign detector 130 wants to know in a corporate environment which email inboxes get hammered with the most amount of malicious emails because, potentially due to their public exposure and they can represent key users.

Both types of inboxes receive large quantities of unsolicited emails, which by nature of being unsolicited is prone to be flagged as anomalous by any system of anomaly detection. The email campaign detector 130 is configured to understand when anomalies are “expected” for certain inboxes but not for others. The email campaign detector 130 uses an autonomous response module 135, and this understanding can be used to adjust the autonomous response: a less-severe response for inboxes that expect unsolicited or anomalous (but non-threatening) mail and a more-severe response for those email accounts such as key email user accounts that do not.

The email campaign detector 130 uses the machine learning anomaly-detection system to already analyze all of the emails and assign one or more threat scores to individual emails. The email campaign detector 130 can analyze the distribution of threat scores for both types of inboxes to look for a more random spread for public-facing inboxes, and threat scores were concentrated at the higher end of the scale for key email user accounts (e.g., the executives') inboxes.

The email campaign detector 130 has an AI classifier and/or scripted algorithm that is able to analyze every inbox in an environment—by analyzing existing threat scores, assigning the scores to categories, and logging them over time.

Counts are fed into a probability function that maintains a score for each inbox; thereby, the email campaign detector 130 estimates the likelihood that type of inbox should receive unsolicited mail. Following a period of learning in an example live environment, the AI classifier was able to identify the public-facing mailboxes with very few false positives.

The AI classifier and the autonomous response module 135 cooperate in the email campaign detector 130 to better-tailored autonomous response that will be taken against unsolicited emails based on a type of email inbox account. Autonomous detection of an intended function of a corporate inbox and whether the corporate inbox under analysis that is receiving a higher amount of malicious emails than the typical corporate inbox is associated with a low priority intended recipient (account or user) or a high priority intended recipient. When the intended recipient corporate inbox is a high priority intended recipient, such as a CEO, then the autonomous response should increase its level of stringency in the actions it takes against those malicious emails (e.g., not pass attached documents and/or links without a quarantine or stripping. When the intended recipient corporate inbox is a low priority intended recipient, such as the published corporate inbox info@companyname.com, then the autonomous response can maintain the level of stringency in the actions it takes against those malicious emails. Corporate inboxes for low priority intended recipients typically either have extra stringency on how emails are handled and/or have limited exposure to other key portions of a network. The email campaign detector 130 can also look at an anomalous level/severity level of suspicious emails, such as a highly targeted phishing email, to determine a priority level of an intended recipient.

The email campaign detector 130 can reduce and put under control email alert fatigue by supplying a notice that a targeted campaign of malicious emails is occurring. This detection can narrow down several alerts into a single, meta-alert for the campaign that needs to be addressed by the human cyber security team. This can also assure the client that the campaign of malicious emails has been actioned, even retrospectively. Also, reducing false positives is also a major focus, as these disrupt business operations—the higher fidelity of the detections of truly malicious emails are, then the less the cyber security appliance 100 disrupts the business operations. The system tries to minimize disrupting business operations by not holding or rendering aspects of a link or an attachment useable for every email with similar characteristics. Similarly, our “self-correction” prevents emails from being scooped up into an unrelated campaign detection of malicious emails.

An average sized company can receive a significant amount of bad/malicious emails aimed at huge numbers of employees such as 50 to 750 of those bad/malicious emails come in at once in a targeted campaign of malicious emails, as well as mass spam emails. When a human cyber analyst is tasked with individually investigating those malicious emails and not seeing them within the context of a single related campaign of malicious emails can overwhelm the human cyber analyst. However, when the email campaign detector 130 supplies a notice that a targeted campaign of malicious emails is occurring, then the human can conduct a quick investigation which minimizes the amount of work they have to do.

Detection of targeted campaigns of malicious emails is based upon a concept of unusualness and deviation from a normal behavior—rather than a list of keywords or known bad actors (e.g., “covid19” or “crypto” in the email subject), is an unusual approach.

The email module 120 may contain additional modules. For example, an email similarity scoring module compares an incoming email, based on a semantic similarity of multiple aspects of the email to a cluster of different metrics derived from known bad emails to derive a similarity score between an email under analysis and the cluster of different metrics derived from known bad emails. An email layout change predictor module analyzes changes in an email layout of an email of a user in that email domain to assess whether malicious activity is occurring to an email account of that user, based on the changes in the email layout of the email deviating from a historical norm. The email layout change predictor module detects anomaly deviations by considering two or more parameters of an email selected from a group consisting of a layout of the email, a formatting of the email, a structure of an email body including any of the content, language-usage, subjects, and sentence construction within the email body in order to detect a change in behavior of the email sender under analysis that is indicative of their account being compromised. An image-tracking link module cooperates with an image-tracking link detector to analyze the link properties that describe the link's visual style and appearance accompanying the link to detect whether the tracking link is intentionally being hidden as well as a type of query requests made by the tracking link to determine if this tracking link is a suspicious covert tracking link.

The cyber security appliance 100 may be hosted on a computing device, on one or more servers, and/or in its own cyber-threat appliance platform (e.g., see FIG. 3).

FIG. 2C illustrates the handling of malicious email threats based on whether the targeted user is a vip user. FIG. 2 shows the one or more machine learning models 160A-160D cooperating with and assisting in malicious email detection. In one embodiment, an email is classified as malicious when its threat score (e.g., produced by machine learning analysis) exceeds a predefined threshold. The machine learning models 160A-160D also collaborate with the vip determination module 190, particularly in identifying malicious emails that are targeted at specific users. The vip determination module 190, using the importance score calculated by the user importance scoring module 195, determines whether a user is a vip user.

As having been described in detail above, the user importance scoring module 195 is configured to compute the user importance score for a user based on several. These can include the number of inbound emails for the user from new external senders, the number of inbound emails targeted at just the user or a small group of users including the user, the number of malicious inbound emails for the user, and one or more dampening factors.

In one embodiment, the number of inbound emails from new external senders can be indicative of how often the user serves as the initial contact point for new external entities. A high frequency of such emails can indicate that the user occupies a significant role within the organization, thereby increasing the initial importance score for the user. In one embodiment, the number of inbound emails targeted at just the user or a small group of users can be used to determine whether the importance score for the user should be further increased. If a user frequently receives emails that are not widely distributed within the organization, it can suggest that the user is involved in specific, potentially high-stakes discussions or projects. This factor is particularly useful in ensuring that receiving mass-distributed, newsletter-like emails does not unduly inflate the importance scores for users.

In one embodiment, the number of malicious inbound emails for the user, is also taken into account. A high frequency of malicious emails targeting a user can indicate that external malicious actors perceive the user as a valuable target, which can elevate the importance score of the user.

In addition to the above factors, the user importance scoring module 195 is also configured to take into account one or more dampening factors. The dampening factors can reduce the importance score of a user based on certain behaviors. In one embodiment, a dampening factor considers the frequency of the user sending outbound email communication to new external senders. If a user frequently replies to communication sent by new external senders, it can suggest a less senior role, because it can be assumed that a vip user is not likely to respond to cold calls with regularity.

In one embodiment, a dampening factor takes into account the regularity of a user sending high frequency outbound emails. Users who consistently send out a high volume of emails may be automated email addresses, which are typically less important than human users. In one embodiment, a dampening factor considers whether a user sends few or no outbound emails over a certain period. This can indicate that the user has left the organization or is otherwise no longer active, leading to a reduction in the importance score of the user. In one embodiment, a dampening factor evaluates the frequency of a user's email communications with email addresses hosted at free email domains. Regular communication with such addresses can suggest a role in customer service or HR/recruitment, which may not be as important as other roles.

In one embodiment, a dampening factor considers whether a user is rarely included in email threads with external participants by their colleagues. Infrequent inclusion in such threads can suggest a more isolated role within the organization. Such a user may be an isolated public-facing role, which is less important. In one embodiment, a dampening factor takes into account whether a user is often included in email threads that do not involve other high-importance colleagues. Regular inclusion in such threads can suggest that the user is not involved in critical discussions or projects of the organization.

Once the user importance score is computed, it is utilized by the vip determination module 190 to ascertain whether a user is a vip user. The vip determination module 190 is configured to determine that a user is a vip user when the importance score of the user, as calculated by the user importance scoring module 195, is greater than a predefined threshold; otherwise, the vip determination module 190 is configured to determine that the user is not a vip user. If a malicious email targets a vip user, the autonomous response module 135 is configured to take appropriate action based on vip-specific threat handling rules, which can specify less disruptive or intrusive measures. Conversely, if a malicious email targets a non-vip user, the autonomous response module 135 is configured to take appropriate action based on non-VIP-specific threat handling rules. This ensures that the response of the security system is tailored to the importance of the user, minimizing disruption for vip users while still maintaining robust security measures. In one embodiment, a communication module (not shown) is configured to notify a system administrator if a user is characterized to be the vip user and autonomous actions based on the vip-specific threat-handling rules have been taken against malicious emails that target the vip user.

FIG. 3 illustrates a block diagram of an embodiment of the cyber security appliance monitoring email activity and network activity to feed this data to correlate causal links between these activities to supply this input into the cyber-threat analysis. The network can include various computing devices such as desktop units, laptop units, smart phones, firewalls, network switches, routers, servers, databases, Internet gateways, the cyber security appliance 100, etc.

The network module uses the probes, including the set of detectors, to monitor network activity and can reference the machine learning models 160A trained on a normal behavior of users, devices, and interactions between them or the internet which is subsequently tied to the email system. Likewise, the email module 120 uses the probes, including the set of detectors, to monitor email activity.

The user interface has both i) one or more windows to present/display network data, alerts, and events, and ii) one or more windows to display email data, alerts, events, and cyber security details about those emails through the same user interface on a display screen. These two sets of information shown on the same user interface on the display screen allows a cyber professional to pivot between network data and email cyber security details within one platform and consider them as an interconnected whole rather than separate realms.

The network module and the machine learning models 160A-160D are utilized to determine potentially unusual network activity in order to provide an additional input of information into the cyber threat analyst module 125 in order to determine the threat risk parameter (e.g., a score or probability) indicative of the level of threat. A particular user's network activity can be tied to their email activity because the network module observes network activity, and the network & email coordinator module receives the network module observations to draw that into an understanding of this particular user's email activity to make an appraisal of potential email threats with a resulting threat risk parameter tailored for different users in the e-mail system. The network module tracks each user's network activity and sends that to the network & email coordinator component to interconnect the network activity and email activity to closely inform one-another's behavior and appraisal of potential email threats. The email module and the machine learning models 160A-160D are utilized to determine potentially unusual emails and email activity in order to provide an additional input of information into the cyber threat analyst module 125 in order to determine the threat risk parameter (e.g., a score or probability) indicative of the level of threat by the cyber threat introduced via email. An example probe for the email system may be configured to work directly with an organization's email application, such as an Office 365 Exchange domain and receive a Blind Carbon Copy (BCC) of all ingoing and outgoing communications. The email module 120 will inspect the emails to provide a comprehensive awareness of the pattern of life of an organization's email usage.

The cyber security appliance 100 can now track possible malicious activity observed by the network module on an organization's network back to a specific email event observed by the e-mail module, and use the autonomous response module 135 to shut down any potentially harmful activity on the network itself, and also freeze any similar email activity triggering the harmful activity on the network.

As discussed, the probes, including the set of detectors, collect the user activity as well as the email activity. The collected activity is supplied to the data store for storage of this information and subsequently evaluated for unusual or suspicious behavioral activity, e.g., alerts, events, etc., by the modules. The collected data can also be used to potentially update the training for the one or more machine learning models 160A trained on the normal pattern of life of user activity and email activity for this email system, its users and the network and its entities.

The cyber threat defense system 100 for email derives a wide range of metadata from observed email communications which it analyzes with one or more machine learning models 160A to form a ‘pattern-of-life’ of user activity and email activity for the email system of a given organization. This pattern-of-life recognizes and maps associations between users to generate a probabilistic likelihood that the two or more users would be included in the same communication, decreasing false positive rates and identifying intelligent attacks. This baseline ‘normal’ for the organization includes a fingerprint of email communications for all internal and external senders seen which is compared with any new communications to detect subtle behavioral shifts that may indicate compromise.

One or more machine learning models 160A are trained to gain an understanding of a normal pattern of life of email activity and user activity associated with email domain. For example, the models 160A train on content a user of the network views and/or sites frequented inside and outside of the network as well as checks e-mail history to see if it is probable that this email user would be receiving this particular e-mail under analysis. The models train on e-mail usage pattern of life, content style, contacts, and group associations of each e-mail users in that system. The models 160A cooperating with the email module 120 and cyber threat analyst module 125 can then determine what is the likelihood that this e-mail under analysis falls outside of that normal pattern of life of email activity and user activity for that e-mail user. The module's analysis is married/combined with an output from one or more machine learning models 160B trained on gaining an understanding of all of the characteristics of each e-mail itself and its related data, classification properties of the e-mail, and what is the likelihood the e-mail under analysis falls outside of being a normal benign email. Combining both analyses can allow the targeted campaign classifier 150 to determine a likelihood of multiple emails that are highly similar in nature being i) sent to or ii) received by, the collection of individuals targeted by that mass mailing of highly similar emails currently under analysis, all sent out at about the same time. The e-mail may be highly similar in nature when a comparison of the emails indicate that they have, for example, similar content, similar subject line, similar sender and/or domain, etc.; and thus, share many similar characteristics.

Note, the cyber threat analyst module 125 cooperating with the email module 120 and the one or more machine learning models 160A-160D can also factor associations and anomalies that do not correspond to associations for that email account and/or user. The cyber threat analyst module 125 cooperating with the email module 120 and the one or more machine learning models 160A-160D works out whom the email account and/or the user know such as in their contacts, whom the email account and/or the user communicate with, and other factors like e-mail addresses from a same organization. Thus, the cyber threat analyst module 125 cooperating with the email module 120 and the one or more machine learning models 160A-160D can work out, in essence, how many degrees of separation exist between the sender of an e-mail and the email account and/or user. The cyber threat analyst module 125 cooperating with the email module 120 and the one or more machine learning models 160A-160D can then use these associations as a factor in the determination of how likely would it be that a substantially similar email would be sent to or be received by that set of e-mail recipients. The targeted campaign classifier 150 factors into the likelihood determination factors such as historical trends for that network for associations, entries in the users list of contacts, how close in time the emails are sent, similarity in content and other aspects, how unusual that collection of individuals are being grouped together in this email, etc.

For every email observed by the email module 125, the system derives certain metrics from the nature of the formatting (such as, but absolutely not limited to, the font used, the spacing, the paragraph styles, any images or tables etc.). These metrics are fed to an analyzer which uses unsupervised machine learning to establish a baseline of normal formatting for a user which is updated regularly (such as daily but could be a lot more frequent). The analyzer outputs a prediction of a standard model of that user's behavior which is compared to the metric values seen in the observed email, and a level of anomaly is outputted a) as an overall % score for implementation in detection logic, b) as individual scores for each metric which is fed to further machine learning analyzers which look at the overall unusualness of user behavior.

Referring back to FIG. 1, as discussed, the cyber-threat analyst module can cooperate with the machine learning models 160A-160D and the assessment module to determine a threat risk parameter that factors in how the chain of unusual behaviors correlate to potential cyber threats and ‘the likelihood that this chain of one or more unusual behaviors of the email activity and user activity under analysis fall outside of derived normal benign behavior;’ and thus, is malicious behavior.

The user interface can graphically display logic, data, and other details that the cyber threat analyst module 125 goes through.

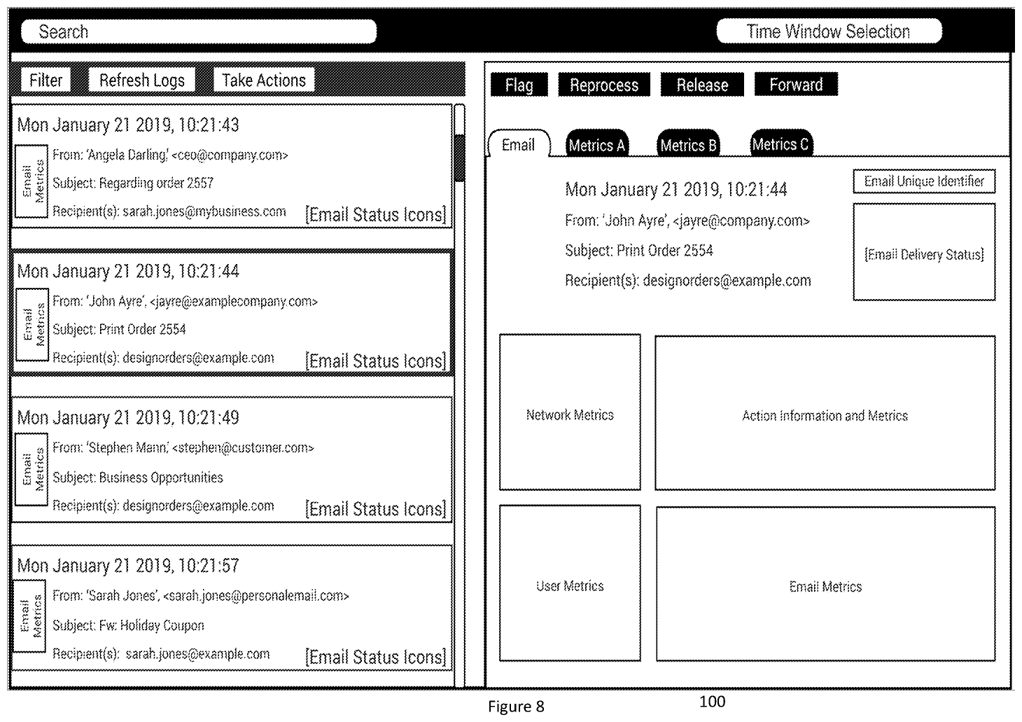

The user interface displays an example email that when undergoing analysis exhibits characteristics, such as header, address, subject line, sender, recipient, domain, etc. and/or behavior that are not statistically consistent with the normal email activity for this user in this email domain. (See FIG. 8 for example) Thus, the user interface displays an example email's unusual activity that the email module 120 referencing the one or more machine learning models 160A has classified as a behavioral anomaly.

During the analysis, the email module 120 can reference the one or more machine learning models 160 that are self-learning models trained on a normal pattern of life of email activity and user activity associated with an email system. This can include various e-mail policies and rules that are set for this email system. The cyber threat analyst module 125 may also reference the models 160B that are trained on the normal characteristics of the email itself. The cyber threat analyst module 125 can apply these various trained machine learning models 160A-160C to data including metrics, alerts, events, metadata from the network module and the email module 120. In addition, a set of AI models 160A may be responsible for learning the normal pattern of life of email activity and user activity for internal and external address identities in connection with the rest of the network, for each email user. This allows the system to neutralize malicious emails which deviate from the normal ‘pattern of life’ for a given email user in relation to their past, their peer group, and the wider organization.

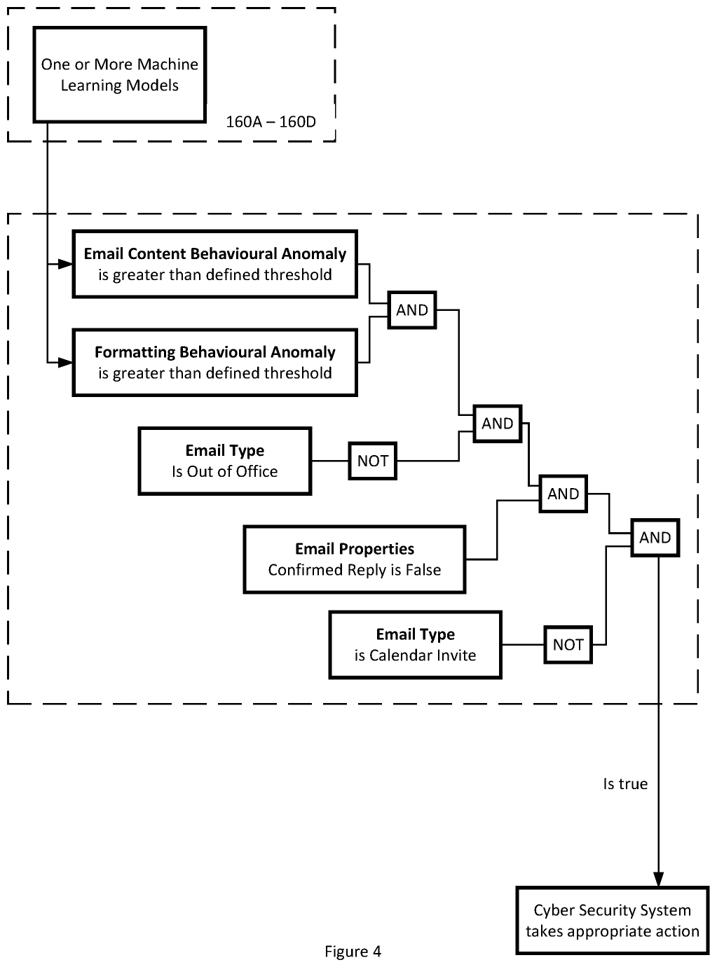

Next, the email module 120 has at least a first email probe to inspect an email at the point it transits through the email application, such as Office 365, and extracts hundreds of data points from the raw email content and historical email behavior of the sender and the recipient. These metrics are combined with pattern of life data of the intended recipient, or sender, sourced from the data store. The combined set of the metrics are passed through machine learning algorithms to produce an anomaly score of the email, and various combinations of metrics will attempt to generate notifications which will help define the ‘type’ of email. (See FIG. 4 for example.)

Email threat alerts, including the type notifications, triggered by anomalies and/or unusual behavior of ‘emails and any associated properties of those emails’ are used by the cyber threat analyst module 125 to better identify any network events which may have resulted from an email borne cyber threat attack. In conjunction with the specific threat alerts and the anomaly score, the system via the autonomous response module 135 may provoke actions upon the email designed to prevent delivery of the email or to neutralize potentially malicious content.

FIG. 4 illustrates a block diagram of an embodiment of the cyber security appliance referencing one or more machine learning models trained on gaining an understanding of a plurality of characteristics on an email itself and its related data including classifying the properties of the email and its metadata. The email module 120 system extracts metrics from every email inbound and outbound.

The user interface can graphically display logic, data, and other details that the cyber security appliance goes through. The cyber threat analyst module 125 in cooperation with the machine learning models 160A-160D analyzes these metrics in order to develop a rich pattern of life for the user activity and email activity in that email system. This allows the cyber threat analyst module 125 in cooperation with the email module 120 to spot unusual anomalous emails and/or behavior that have bypassed/gotten past the existing email gateway defenses.

The email module 120 detects emails whose content is not in keeping with the normal pattern of content as received by this particular recipient.

An example analysis may be as follows.
Is the e-mail content behavioral anomaly greater than the define threshold?
Is the formatting behavioral anomaly greater than the defined threshold?
What type of e-mail is this? An out of office e-mail, some kind of mass association email spam or targeted campaign of e-mails?
What type of e-mail properties does this e-mail have? If the autonomous response module generates sends a reply, do we get a false confirm confirmation?
Is the e-mail type a calendar invite?

Thus, the cyber threat analyst module 125 can also reference the machine learning models 160C trained on an email itself and its related data 160B and the machine learning models trained on potential cyber threats and their characteristics to determine if an email or a set of emails under analysis have potentially malicious characteristics. The cyber threat analyst module 125 can also factor this email characteristics analysis into its determination of the threat risk parameter.

The email module 120 can retrospectively process an email application's metadata, such as Office 365 metadata, to gain an intimate knowledge of each of their users, and their email addresses, correspondents, and routine operations. The power of the cyber threat analyst module 125 lies in leveraging this unique understanding of day-to-day user email behavior, of each of the email users, in relation to their past, to their peer group, and to the wider organization. Armed with the knowledge of what is ‘normal’ for a specific organization and the specific individual, rather than what fits a predefined template of malicious communications, the cyber threat analyst module 125 can identify subtle, sophisticated email campaigns which mimic benign communications and locate threats concealed as everyday activity.

Next, the email module 120 provides comprehensive email logs for every email observed. These logs can be filtered with complex logical queries and each email can be interrogated on a vast number of metrics in the email information stored in the data store.

Some example email characteristics that can be stored and analyzed are:
Email direction: Message direction—outbound emails and inbound emails.
Send Time: The send time is the time and date the email was originally sent according to the message metadata.
Links: Every web link present in an email has its own properties. Links to web sites are extracted from the body of the email. Various attributes are extracted including, but not limited to, the position in the text, the domain, the frequency of appearance of the domain in other emails and how it relates to the anomaly score of those emails, how well that domain fits into the normal pattern of life of the intended recipient of the email, their deduced peer group and their organization.
Recipient: The recipient of the email. If the email was addressed to multiple recipients, these can each be viewed as the ‘Recipients’. The known identifying properties of the email recipient, including how well known the recipient was to the sender, descriptors of the volume of mail, and how the email has changed over time, to what extent the recipient's email domain is interacted with inside the network.
Subject: The email subject line.
Attachment: Every attachment associated with the message will appear in the user interface here as individual entries, with each entry interrogatable against both displayed and advanced metrics. These include, but are not limited to, the attachment file name, detected file types, descriptors of the likelihood of the recipient receiving such a file, descriptors of the distribution of files such of these in all email against the varying anomaly score of those emails.
Headers: Email headers are lines of metadata that accompany each message, providing key information such as sender, recipient, message content type for example.

FIG. 5 illustrates an example of the network module informing the email module 120 of a computer's network activity prior to the user of that computer receiving an email containing content relevant to that network activity.

FIG. 6 illustrates an example of the network module informing the email module 120 of the deduced pattern of life information on the web browsing activity of a computer prior to the user of that computer receiving an email that contains content which is not in keeping with that pattern of life. The network and email coordinator module merges network knowledge with email knowledge to better understand what is normal and expected and what is unusual via the network module communicating with the email module 120.

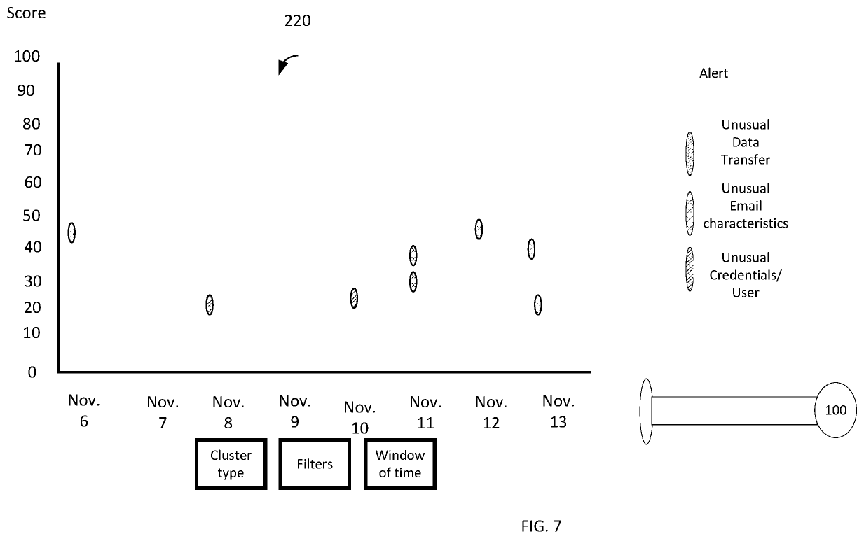

In FIG. 7, the user interface can display a graph 220 of an example chain of unusual behavior for the email(s) in connection with the rest of the network under analysis and how the cyber-threat analyst module cooperating with the assessment module and the machine learning models determine a threat risk parameter that factors in how the chain of unusual behaviors correlate to potential cyber threats.

The cyber threat analyst module 125 cooperates with one or more machine learning models 160D trained on how to conduct a cyber threat investigation. The one or more machine learning models 160D are trained and otherwise configured with mathematical algorithms to infer, for the cyber-threat analysis, ‘what is possibly happening with the chain of distinct alerts and/or events, which came from the unusual pattern,’ and then assign a threat risk associated with that distinct item of the chain of alerts and/or events forming the unusual pattern. The cyber threat analyst module can also rely on a set of scripted algorithms to go through the steps of conducting a cyber threat investigation.

In an example, a behavioral pattern analysis of what are the unusual behaviors of the network/system/device/user under analysis by the machine learning models 160A may be as follows. The network module & email coordinator module 120 can tie the alerts and events from the email realm to the alerts and events from the IT network realm. The graph 220 shows an example chain of unusual behavior for, in this example, the email activities as well as IT activities deviating from a normal pattern of life for this user and/or device in connection with the rest of the system/network under analysis. The cyber threat analyst module can cooperate with one or more machine learning models. The one or more machine learning models 160D are trained and otherwise configured with mathematical algorithms to infer, for the cyber-threat analysis, ‘what is possibly happening with the chain of distinct alerts, activities, and/or events, which came from the unusual pattern,’ and then assign a threat risk associated with that distinct item of the chain of alerts and/or events forming the unusual pattern. The unusual pattern can be determined by examining initially what activities/events/alerts that do not fall within the window of what is the normal pattern of life for that network/system/device/user under analysis can be analyzed to determine whether that activity is unusual or suspicious. A chain of related activity that can include both unusual activity and activity within a pattern of normal life for that entity can be formed and checked against individual cyber threat hypothesis to determine whether that pattern is indicative of a behavior of a malicious actor—human, program, or other threat. The cyber threat analyst module 125 can go back and pull in some of the normal activities to help support or refute a possible hypothesis of whether that pattern is indicative of a behavior of a malicious actor. An example behavioral pattern included in the chain is shown in the graph over a time frame of, an example, 7 days. The cyber threat analyst module 125 detects a chain of anomalous behavior of unusual data transfers three times, unusual characteristics in emails in the monitored system three times which seem to have some causal link to the unusual data transfers. Likewise, twice unusual credentials attempted the unusual behavior of trying to gain access to sensitive areas or malicious IP addresses and the user associated with the unusual credentials trying unusual behavior has a causal link to at least one of those three emails with unusual characteristics. Again, the cyber security appliance 100 can go back and pull in some of the normal activities to help support or refute a possible hypothesis of whether that pattern is indicative of a behavior of a malicious actor. The cyber threat analyst module 125 can cooperate with one or more models trained on cyber threats and their behavior to try to determine if a potential cyber threat is causing these unusual behaviors. The cyber threat analyst module 125 can put data and entities into 1) a directed graph and nodes in that graph that are overlapping or close in distance have a good possibility of being related in some manner, 2) a vector diagram, 3) relational database, and 4) other relational techniques that will at least be examined to assist in creating the chain of related activity connected by causal links, such as similar time, similar entity and/or type of entity involved, similar activity, etc., under analysis. If the pattern of behaviors under analysis is believed to be indicative of a malicious actor, then a score of how confident is the system in this assessment of identifying whether the unusual pattern was caused by a malicious actor is created. Next, also assigned is a threat level score or probability indicative of what level of threat does this malicious actor pose. Lastly, the cyber security appliance 100 is configurable in a user interface, by a user, enabling what type of automatic response actions, if any, the cyber security appliance 100 may take when different types of cyber threats, indicated by the pattern of behaviors under analysis, that are equal to or above a configurable level of threat posed by this malicious actor.

The cyber threat analyst module 125 may chain the individual alerts and events that form the unusual pattern into a distinct item for cyber-threat analysis of that chain of distinct alerts and/or events. The cyber threat analyst module 125 may reference the one or more machine learning models 160C trained on e-mail cyber threats to identify similar characteristics from the individual alerts and/or events forming the distinct item made up of the chain of alerts and/or events forming the unusual pattern. These machine learning models 160C are trained on characteristics and aspects of all manner of types of cyber threats to analyze the threat risk associated with the chain/cluster of alerts and/or events forming the unusual pattern. The machine learning technology, using advanced mathematics, can detect previously unidentified threats, without rules, and automatically defend networks.

The detectors in the network module and email module 120 components can be discrete mathematical models that implement a specific mathematical method against different sets of variables with the target.

At its core, the cyber security appliance mathematically characterizes what constitutes ‘normal’ behavior based on the analysis of a large number/set of different measures of a device's network behavior. The cyber security appliance can build a sophisticated ‘pattern of life’—that understands what represents normality for every person, device, email activity, and network activity in the system being protected by the cyber security appliance.

As discussed, each machine learning model may be trained on specific aspects of the normal pattern of life for the system such as devices, users, network traffic flow, outputs from one or more cyber security analysis tools analyzing the system, email contact associations for each user, email characteristics, etc. The one or more machine learning models 160A may use at least unsupervised learning algorithms to establish what is the normal pattern of life for the system. The machine learning models 160A can train on both i) the historical normal distribution of alerts and events for that system as well as ii) factored in is a normal distribution information from similar peer systems to establish the normal pattern of life of the behavior of alerts and/or events for that system. Another set of machine learning models train on characteristics of emails 160B.

In addition, the one or more machine learning models can use the comparison of i) the normal pattern of life for that system corresponding to the historical normal distribution of alerts and events for that system mapped out in the same multiple dimension space to ii) the current chain of individual alerts and events behavior under analysis. This comparison can yield detection of the one or more unusual patterns of behavior within the plotted individual alerts and/or events, which allows the detection of previously unidentified cyber threats compared to finding cyber threats with merely predefined descriptive objects and/or signatures. Thus, increasingly intelligent malicious cyber threats that try to pick and choose when they take their actions in order to generate low level alerts and event will still be detected, even though they have not yet been identified by other methods of cyber analysis. These intelligent malicious cyber threats can include malware, spyware, key loggers, malicious links in an email, malicious attachments in an email, phishing emails, etc. as well as nefarious internal information technology staff who know intimately how to not set off any high level alerts or events.

In essence, the plotting and comparison is a way to filter out what is normal for that system and then be able to focus the analysis on what is abnormal or unusual for that system. Then, for each hypothesis of what could be happening starting with this chain of unusual events and/or alerts, then the gatherer module may gather additional metrics from the data store including the pool of metrics originally considered ‘normal behavior’ to support or refute each possible hypothesis of what could be happening with this chain of unusual behavior under analysis.

Note, each of the individual alerts and/or events in a chain of alerts and/or events that form the unusual pattern can indicate subtle abnormal behavior; and thus, each alert and/or event can have a low threat risk associated with that individual alert and/or event. However, when analyzed as a distinct chain/grouping of alerts and/or events behavior forming the chain of unusual pattern by the one or more machine learning models, then that distinct chain of alerts and/or events can be determined to now have a much higher threat risk than any of the individual alerts and/or events in the chain.

Note, in addition, today's cyberattacks can be of such severity and speed that a human response cannot happen quickly enough. Thanks to these self-learning advances, it is now possible for a machine to uncover these emerging threats and deploy appropriate, real-time responses to fight back against the most serious cyber threats.

The threat detection system has the ability to self-learn and detect normality in order to spot true anomalies, allowing organizations of all sizes to understand the behavior of users and machines on their networks at both an individual and group level. Monitoring behaviors, rather than using predefined descriptive objects and/or signatures, means that more attacks can be spotted ahead of time and extremely subtle indicators of wrongdoing can be detected. Unlike traditional legacy defenses, a specific attack type or new malware does not have to have been seen first before it can be detected. A behavioral defense approach mathematically models both machine, email, and human activity behaviorally, at and after the point of compromise, in order to predict and catch today's increasingly sophisticated cyber-attack vectors. It is thus possible to computationally establish what is normal, in order to then detect what is abnormal. In addition, the machine learning constantly revisits assumptions about behavior, using probabilistic mathematics. The cyber security appliance's unsupervised machine learning methods do not require training data with pre-defined labels. Instead, they are able to identify key patterns and trends in the data, without the need for human input.

FIG. 8 illustrates a block diagram of an embodiment of an example window of the user interface with an inbox-style view of all emails coming in/out of an email domain and the cyber security characteristics known about one or more e-mails under analysis.

The user interface of the cyber security appliance 100 allows emails in the e-mail system to be filterable, searchable, and sortable, configured in appearance to be in a style like an email application's user interface that a typical user is familiar with. The user interface allows emails in the e-mail system to be filterable, searchable, and sortable to customize and target the one or more emails under analysis in the first window and then show alongside a second window with the relevant security characteristics known about those one or more emails. Thus, these two windows display their respective information on the same display screen with this user interface to allow a cyber professional analyzing the emails under analysis to better assess whether those one or more emails are in fact a cyber threat. The user interface gives a cyber professional the ability to investigate and customize very complex machine learning and then see the resulting analysis of an email or a set of emails in a graphical user interface that is easy to grasp and familiar in appearance.

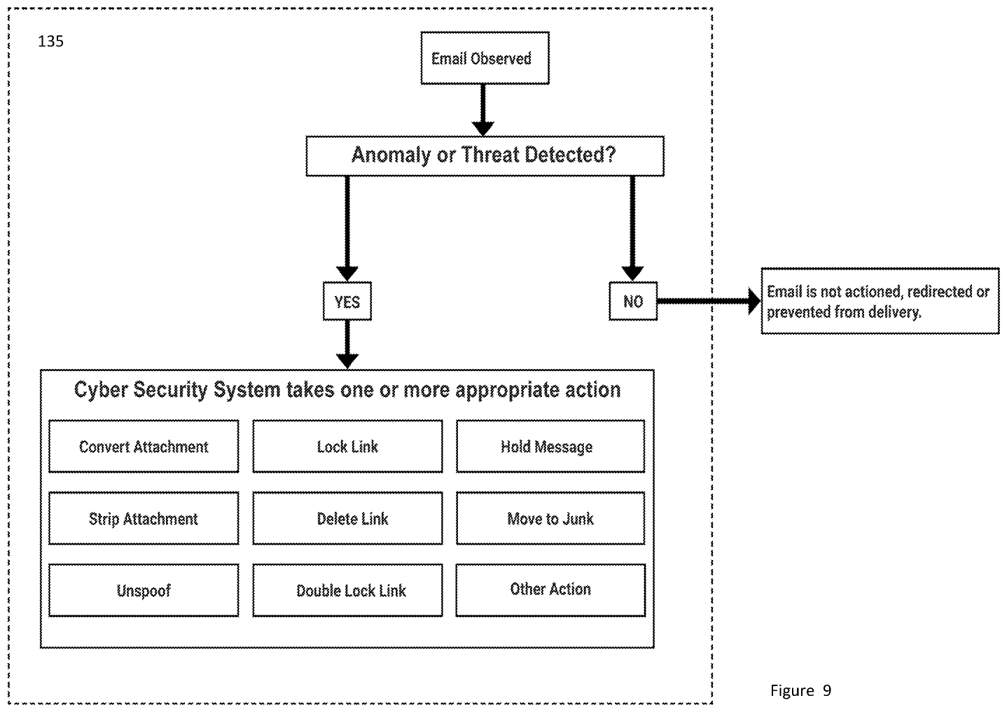

FIG. 9 illustrates a block diagram of an embodiment of example autonomous actions that the autonomous response module can be configured to take without a human initiating that action.

The autonomous response module 135 is configurable, via the user interface, to know when it should take the autonomous actions to contain the cyber-threat when i) a known malicious email or ii) at least highly likely malicious email is determined by the cyber threat analyst module 125. The autonomous response module 135 has an administrative tool, configurable through the user interface, to program/set what autonomous actions the autonomous response module 135 can take, including types of actions and specific actions the autonomous response module 135 is capable of, when the cyber threat analyst module 125 indicates the threat risk parameter is equal to or above the actionable threshold, selectable by the cyber professional, that the one or more emails under analysis are at least highly likely to be malicious.

The types of actions and specific actions the autonomous response module 135 customizable for different users and parts of the system; and thus, configurable for the cyber professional to approve/set for the autonomous response module 135 to automatically take those actions and when to automatically take those actions.

The autonomous response module 135 has a library of response action types of actions and specific actions the autonomous response module 135 is capable of, including focused response actions selectable through the user interface that are contextualized to autonomously act on specific email elements of a malicious email, rather than a blanket quarantine or block approach on that email, to avoid business disruption to a particular user of the email system. The autonomous response module 135 is able to take measured, varied actions towards those email communications to minimize business disruption in a reactive, contextualized manner.

The autonomous response module 135 works hand-in-hand with the AI models to neutralize malicious emails, and deliver preemptive protection against targeted, email-borne attack campaigns in real time.

The cyber threat analyst module 125 cooperating with the autonomous response module 135 can detect and contain, for example, an infection in the network, recognize that the infection had an email as its source, and identify and neutralize that malicious email by either removing that from the corporate email account inboxes, or simply stripping the malicious portion of that before the email reaches its intended user. The autonomous actions range from flattening attachments or stripping suspect links, through to holding emails back entirely if they pose a sufficient risk.

The cyber threat analyst module 125 can identify the source of the compromise and then invoke an autonomous response action by sending a request to the autonomous response model. This autonomous response action will rapidly stop the spread of an emerging attack campaign and give human responders the crucial time needed to catch up.

In an embodiment, initially, the autonomous response module 135 can be run in human confirmation mode—all autonomous, intelligent interventions must be confirmed initially by a human operator. As the autonomous response module 135 refines and nuances its understanding of an organization's email behavior, the level of autonomous action can be increased until no human supervision is required for each autonomous response action. Most security teams will spend very little time in the user interface once this level is reached. At this time, the autonomous response module 135 response action neutralizes malicious emails without the need for any active management. The autonomous response module 135 may take one or more proactive or reactive action against email messages, which are observed as potentially malicious. Actions are triggered by threat alerts or by a level of anomalous behavior as defined and detected by the cyber-security system and offer highly customizable, targeted response actions to email threats that allows the end user to remain safe without interruption. Suspect email content can be held in full, autonomously with selected users exempted from this policy, for further inspection or authorization for release. User behavior and notable incidents can be mapped, and detailed, comprehensive email logs can be filtered by a vast range of metrics compared to the model of normal behavior to release or strip potentially malicious content from the email.

### Example Possible Actions

The following selection of example actions, categorized into delivery actions, attachment actions, link actions, header and body actions, etc., appear on the dashboard and can be taken by or at least suggested to be taken by the autonomous response module 135 when the threat risk parameter is equal to or above a configurable set point set by a cyber security professional:
Hold Message: The autonomous response module 135 has held the message before delivery due to suspicious content or attachments. Held emails can be reprocessed and released by an operator after investigation. The email will be prevented from delivery, or if delivery has already been performed, removed from the recipient's inbox. The original mail will be maintained in a buffered cache by the data store and can be recovered, or sent to an alternative mailbox, using the ‘release’ button in the user interface.
Lock Links: The autonomous response module 135 replaces the URL of a link such that a click of that link will first divert the user via an alternative destination. The alternative destination may optionally request confirmation from the user before proceeding. The original link destination and original source will be subject to additional checks before the user is permitted to access the source.
Convert Attachments: The autonomous response module 135 converts one or more attachments of this email to a safe format, flattening the file typically by converting into a PDF through initial image conversion. This delivers the content of the attachment to the intended recipient, but with vastly reduced risk. For attachments which are visual in nature, such as images, PDFs and Microsoft Office formats, the attachments will be processed into an image format and subsequently rendered into a PDF (in the case of Microsoft Office formats and PDFs) or into an image of the original file format (if an image). In some email systems, the email attachment may be initially removed and replaced with a notification informing the user that the attachment is undergoing processing. When processing is complete the converted attachment will be inserted back into the email.
Double Lock Links: The autonomous response module 135 replaces the URL with a redirected Email link. If the link is clicked, the user will be presented with a notification to that user that they are not permitted to access the original destination of the link. The user will be unable to follow the link to the original source, but their intent to follow the link will be recorded by the data store via the autonomous response module 135.
Strip Attachments: The autonomous response module 135 strips one or more attachments of this email. Most file formats are delivered as converted attachments; file formats which do not convert to visible documents (e.g., executables, compressed types) are stripped to reduce risk. The ‘Strip attachment’ action will cause the system to remove the attachment from the email and replace it with a file informing the user that the original attachment was removed.
Junk action: The autonomous response module 135 will ensure the email classified as junk or other malicious email is diverted to the recipient's junk folder, or other nominated destination such as ‘quarantine’.
Redirect: The autonomous response module 135 will ensure the email is not delivered to the intended recipient but is instead diverted to a specified email address.
Copy: The autonomous response module 135 will ensure the email is delivered to the original recipient, but a copy is sent to another specified email address.
Do not hold or alter: Can be set on a particular user basis. The autonomous response module 135 will ensure the email(s) are never held, and never altered in any way by the system, regardless of actions performed by other models or triggered by the general anomaly threat level.
Take no action on attachments: Can be set on a particular user basis. This action will override any attachment actions that would be otherwise taken by the autonomous response module 135 whether in response to a particular threat alert or overall detected anomaly level.
Header and body action: The autonomous response module 135 will insert specific, custom text into the email Body or Subject Line to add to or substitute existing text, images, or other content in a header and/or body of the email.
Unspoof: The autonomous response module 135 will identify standard email header address fields (e.g., rfc822 type) and replace the Personal Name and the header email address with an alternative name or email address which might reveal more about the true sender of the email. This mechanism significantly reduces the psychological impact of spoof attempts.

### Defense System

The cyber threat analyst module 125 that forms and investigates hypotheses on what are the possible set of cyber threats can use hypotheses mechanisms including any of 1) one or more AI models 160D trained on how human cyber security analysts form cyber threat hypotheses and how to conduct investigations for a cyber threat hypothesis that would include at least an anomaly of interest, 2) one or more scripts outlining how to conduct an investigation on a possible set of cyber threats hypotheses that would include at least the anomaly of interest, 3) one or more rules-based models on how to conduct an investigation on a possible set of cyber threats hypotheses and how to form a possible set of cyber threats hypotheses that would include at least the anomaly of interest, and 4) any combination of these. Again, the AI models trained 160D on ‘how to form cyber threat hypotheses and how to conduct investigations for a cyber threat hypothesis’ may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 125 and/or the analyzer module can feed the cyber threat details to an assessment module to generate a threat risk score that indicates a level of severity of the cyber threat.

Training of AI Pre Deployment and then During Deployment

In step 1, an initial training of the Machine learning model 160C trained on cyber threats can occur using unsupervised learning and/or supervised learning on characteristics and attributes of known potential cyber threats including malware, insider threats, types of email threats, and other kinds of cyber threats that can occur within that domain. Each Artificial Intelligence can be programmed and configured with the background information to understand and handle particulars, including different types of data, protocols used, types of devices, user accounts, etc. of the system being protected. The Artificial Intelligence pre-deployment can all be trained on the specific machine learning task that they will perform when put into deployment. For example, the AI model 160C trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, the AI model trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cyber security appliance 100, the AI model trained on cyber threats can determine whether a potentially unknown threat has been detected via a number of techniques including an overlap of some of the same characteristics and attributes in that category of cyber threats. The Artificial Intelligence/machine learning models may use unsupervised learning when deployed to better learn newer and updated characteristics of cyber threat attacks.

In an embodiment, the one or more machine learning models 160A trained on a normal behavior of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The machine learning model 160A using unsupervised machine learning understands the system under analysis' normal patterns of life in, for example, a week of being deployed on that system, and grows more bespoke with every passing minute. The machine learning model 160A learns patterns from the features in the day to day dataset and detecting abnormal data which would not have fallen into the category (cluster) of normal behavior. The machine learning model 160A using unsupervised machine learning can simply be placed into an observation mode for an initial week or two when first deployed on a network/domain in order to establish an initial normal behavior for entities in the network/domain under analysis.

A deployed machine learning model 160A trained on a normal behavior of entities in the system can be configured to observe the nodes in the system being protected. Training on a normal behavior of entities in the system can occur while monitoring for the first week or two until enough data has been observed to establish a statistically reliable set of normal operations for each node (e.g., user account, device, etc.). Initial training of the machine learning models 160A trained with machine learning on a behavior of the pattern of life of the entities in the IT network and or email domain can occur specifically to understand components/devices, protocols, activity level, etc. to that type of network/system/domain. Alternatively, pre-deployment machine learning training of one or more machine learning models trained on a normal behavior of entities in the system can occur. Initial training of one or more machine learning models trained with machine learning on a behavior of the pattern of life of the entities in the network/domain can occur where each type of network and/or domain will generally have some common typical behavior with each model trained specifically to understand components/devices, protocols, activity level, etc. to that type of network/system/domain. Again, what is normal behavior of each entity within that system can be established either prior to deployment and then adjusted during deployment or alternatively the model can simply be placed into an observation mode for an initial week or two when first deployed on a network/domain in order to establish an initial normal behavior for entities in the network/domain under analysis.

During deployment, what is considered normal behavior will change as each different entity's behavior changes and will be reflected through the use of unsupervised learning in the model such as various Bayesian techniques, clustering, etc. All of the machine learning models can be implemented with various mechanisms such a neural network, decision trees, etc. and combinations of these. Likewise, one or more supervised machine learning AI models 160D are trained to create possible hypotheses and perform cyber threat investigations on agnostic examples of past historical incidents of detecting a multitude of possible types of cyber threat hypotheses previously analyzed by human cyber threat analysis.

At its core, the self-learning, machine learning models that model the normal behavior (e.g., a normal pattern of life) of entities in the network mathematically characterizes what constitutes ‘normal’ behavior.

Clustering Methods

In order to model what should be considered as normal for a device or cloud container, its behavior can be analyzed in the context of other similar entities on the IT and/or email network. The machine learning models 160A-160C can use unsupervised machine learning to algorithmically identify significant groupings, a task which is virtually impossible to do manually. To create a holistic image of the relationships within the network, The machine learning models 160A-160C and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The machine learning models 160A-160C and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning models 160D are trained to create possible hypotheses and how to perform cyber threat investigations on agnostic examples of past historical incidents of detecting a multitude of possible types of cyber threat hypotheses previously analyzed by human cyber threat analysis. The machine learning models 160D trained on forming and investigating hypotheses on what are a possible set of cyber threats can be trained initially with supervised learning. Thus, these AI models 160D can be trained on how to form and investigate hypotheses on what are a possible set of cyber threats and steps to take in supporting or refuting hypotheses. The AI models 160D trained on forming and investigating hypotheses are updated with unsupervised machine learning algorithms when correctly supporting or refuting the hypotheses including what additional collected data proved to be the most useful.

Ranking the Cyber Threat

The assessment module can cooperate with the AI models 160C trained on possible cyber threats to use AI algorithms to account for ambiguities by distinguishing between the subtly differing levels of evidence that characterize network data. Instead of generating the simple binary outputs ‘malicious’ or ‘benign’, the AI's mathematical algorithms produce outputs marked with differing degrees of potential threat. This enables users of the system to rank alerts in a rigorous manner, and prioritize those which most urgently require action. Meanwhile, it also assists to avoid the problem of numerous false positives associated with simply a rule-based approach.

All of the above AI models 160A-160D can continually learn and train with unsupervised machine learning algorithms on an ongoing basis when deployed in their system that the cyber security appliance 100 is protecting. Thus, the learning and training on what is normal behavior for each user, each device, and the system overall and lowering a threshold of what is an anomaly.

Anomaly Detection/Deviations

Anomaly detection can discover unusual data points in your dataset. Anomaly can be a synonym for the word ‘outlier’. Anomaly detection (or outlier detection) is the identification of rare items, events or observations which raise suspicions by differing significantly from the majority of the data. Anomalous activities can be linked to some kind of problems or rare events. Since there are tons of ways to induce a particular cyber-attack, it is very difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous. The AI unsupervised learning model learns patterns from the features in the day to day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold (a parameter that can be tuned over time through the self-learning), where feature values with probability larger than this threshold indicate that the given feature's values are non-anomalous, otherwise it's anomalous. Note, this anomaly detection can determine that a data point is anomalous/non-anomalous on the basis of a particular feature. In reality, the cyber security appliance 100 should not flag a data point as an anomaly based on a single feature. Merely, when a combination of all the probability values for all features for a given data point is calculated can the modules cooperating with the AI model of normal behavior can say with high confidence whether a data point is an anomaly or not.

Again, the AI models trained on a normal behavior of entities in a system (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. Please reference U.S. Pat. No. 10,701,093 granted Jun. 30, 2020, titled “Anomaly alert system for cyber threat detection” for an example Bayesian probabilistic approach, which is incorporated by reference in its entirety. In addition, please reference US patent publication number “US2021273958A1 filed Feb. 26, 2021, titled “Multi-stage anomaly detection for process chains in multi-host environments” for another example anomalous behavior detector using a recurrent neural network and a bidirectional long short-term memory (LSTM), which is incorporated by reference in its entirety. In addition, please reference US patent publication number “US2020244673A1, filed Apr. 23, 2019, titled “Multivariate network structure anomaly detector,” which is incorporated by reference in its entirety, for another example anomalous behavior detector with a Multivariate Network and Artificial Intelligence classifiers.

The AI models trained on a normal behavior of entities in a domain under analysis may perform the threat detection through a probabilistic change in a normal behavior through the application of, for example, an unsupervised Bayesian mathematical model to detect a behavioral change in computers and computer networks. The Bayesian probabilistic approach can determine periodicity in multiple time series data and identify changes across single and multiple time series data for the purpose of anomalous behavior detection. In an example, a system being protected can include both email and IT network domains under analysis. Thus, email and IT network raw sources of data can be examined along with a large number of derived metrics that each produce time series data for the given metric.

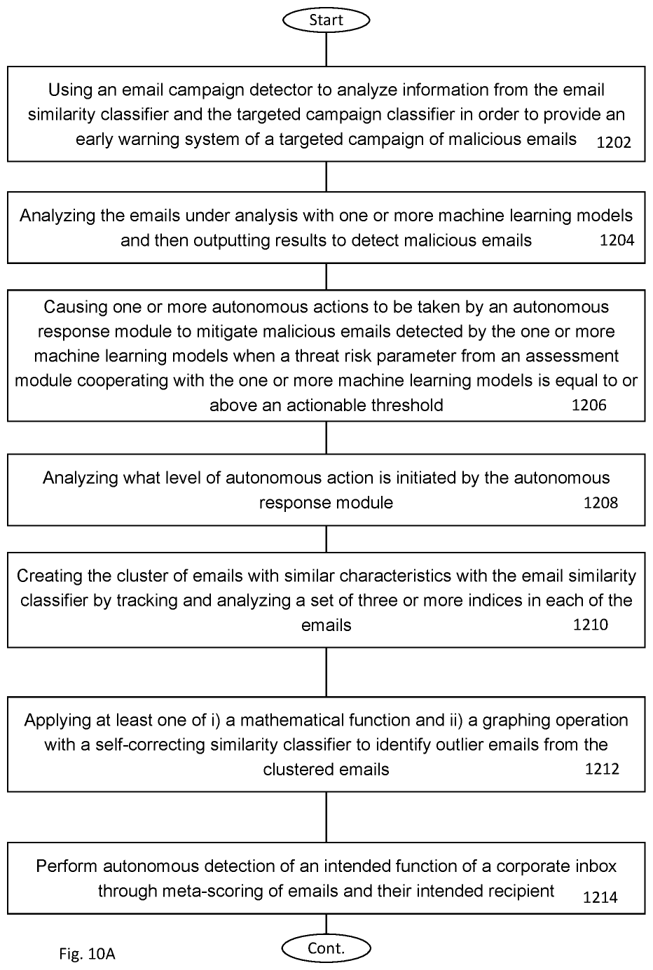

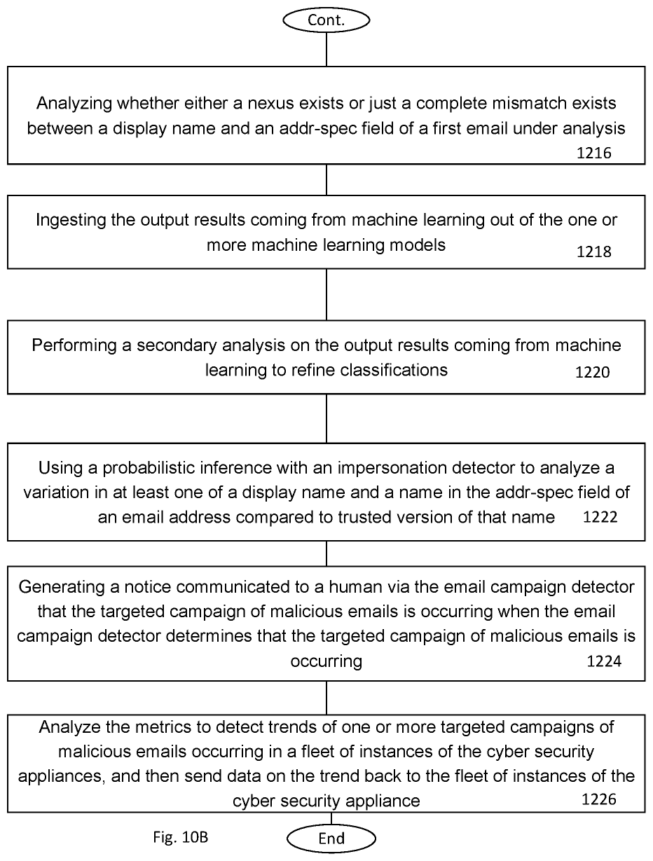

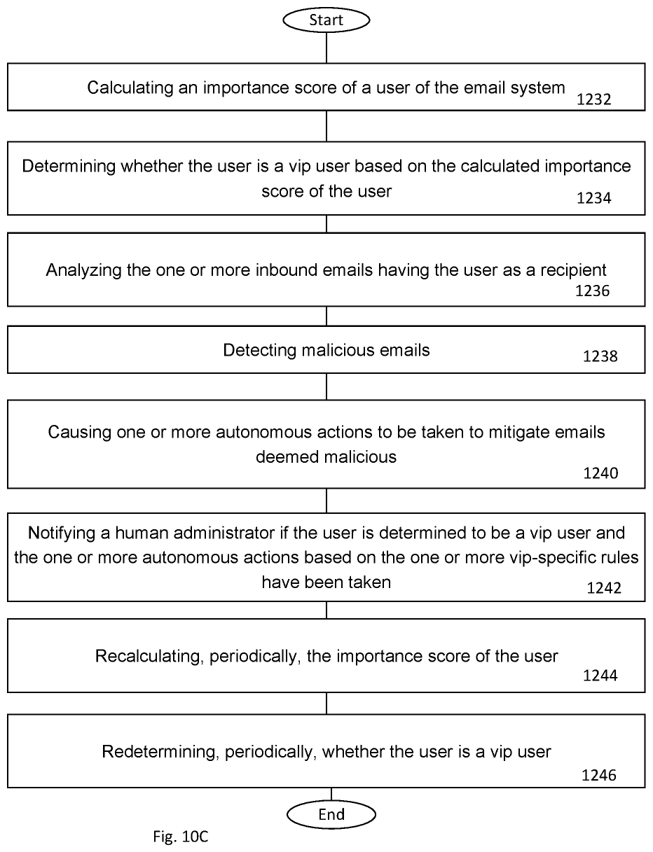

FIGS. 10A and 10B illustrate a flow chart of an embodiment of a method for a cyber security appliance to protect an email system.

In step 1202, using an email campaign detector that has 1) an email similarity classifier configured to analyze a group of emails, under analysis, in order to cluster emails with similar characteristics in the group of emails and 2) a targeted campaign classifier configured to i) analyze the clustered emails with similar characteristics to check whether the clustered emails with similar characteristics are a) coming from a same threat actor b) going to a same intended target, and c) any combination of both, as well as ii) verify whether the clustered emails with similar characteristics are deemed malicious, where the email campaign detector is configured to analyze information from the email similarity classifier and the targeted campaign classifier in order to provide an early warning system of a targeted campaign of malicious emails.

In step 1204, analyzing the emails under analysis with one or more machine learning models and then outputting results to detect malicious emails; where the email campaign detector is configured to cooperate with the one or more machine learning models to identify emails that are deemed malicious.

In step 1206, causing one or more autonomous actions to be taken by an autonomous response module to mitigate malicious emails detected by the one or more machine learning models when a threat risk parameter from an assessment module cooperating with the one or more machine learning models is equal to or above an actionable threshold;

In step 1208, analyzing what level of autonomous action is initiated by the autonomous response module to mitigate emails in the clustered emails with similar characteristics compared to a historical norm of autonomous actions to past groups of clusters of emails that had similar characteristics, and when different and more severe than the historical norm, then the email campaign detector can consider the different and more severe autonomous action taken on the clustered emails as a factor indicating that the targeted campaign of malicious emails is underway.

In step 1210, creating the cluster of emails with similar characteristics with the email similarity classifier by tracking and analyzing a set of three or more indices in each of the emails making up the group of emails, wherein individual indices within that set can vary and be different than other instances of that index in another email but yet still be deemed similar because at least a majority of the indices match up in the set of three or more indices.

In step 1212, applying at least one of i) a mathematical function and ii) a graphing operation with a self-correcting similarity classifier to identify outlier emails from the clustered emails and then remove the outlier emails from the clustered emails; and thus, from the targeted campaign of malicious emails, based on a variation in the output results generated by the machine learning models for the outlier emails compared to a remainder of the emails in the clustered emails with similar characteristics, even though the outlier emails shared similar characteristics with the remainder of the emails in the clustered emails with similar characteristics.

In step 1214, using one or more algorithms scripted to perform autonomous detection of an intended function of a corporate inbox through meta-scoring of emails and their intended recipient, and then once the intended function is determined then to adjust an appropriate autonomous action taken to mitigate the detected malicious emails for a public facing inbox compared to a key email user in an email system.

In step 1216, analyzing whether either a nexus exists or just a complete mismatch exists between a display name and an addr-spec field of a first email under analysis with an impersonation detector as a factor in detecting whether the first email under analysis is malicious; and therefore, potentially part of the targeted campaign of malicious emails.

In step 1218, ingesting the output results coming from machine learning out of the one or more machine learning models, and

In step 1220, performing a secondary analysis on the output results coming from machine learning to refine classifications such as 1) a first email, under analysis, is malicious or not malicious, 2) is part of the targeted campaign of malicious emails or should not be included, and 3) any combination of these, via at least one of i) a mathematical operation and ii) a graphing operation as the secondary analysis on the output results coming from the machine learning.

In step 1222, using a probabilistic inference with an impersonation detector to analyze a variation in at least one of a display name and a name in the addr-spec field of an email address compared to trusted version of that name as a factor in detecting whether an email was generated via spoofing and thus is malicious; and therefore, potentially part of the targeted campaign of malicious email or not malicious.

In step 1224, generating a notice communicated to a human via the email campaign detector that the targeted campaign of malicious emails is occurring when the email campaign detector determines that the targeted campaign of malicious emails is occurring.

In step 1226, encrypting and securely communicating information from the email campaign detector over a network with a centralized fleet aggregator that is configured to cooperate with a database to collate metrics, where the centralized fleet aggregator is further configured to analyze the metrics to detect trends of one or more targeted campaigns of malicious emails occurring in a fleet of instances of the cyber security appliances, and then send data on the trend back to the fleet of instances of the cyber security appliance.

FIG. 10C illustrates a flow chart of an embodiment of a method for a cyber security appliance to protect an email system.

In step 1232, calculating an importance score of a user of the email system. the importance score of the user is calculated based on a number of new inbound senders associated with one or more inbound emails having the user as a recipient over a set period of time (e.g. a recent period of time such as the last 24 hours) and 1) one or more enhancing factors each of which increases the importance score of the user, 2) one or more dampening factors each of which reduces the importance score of the user, or 3) a combination thereof, where a greater number of the new inbound senders corresponds to a higher importance score that corresponds to a higher level of importance of the user.

According to one of the one or more enhancing factors, the importance score of the user is increased in response to each of the one or more inbound emails being associated with fewer than a first threshold number of recipients. According to one of the one or more enhancing factors, the importance score of the user is increased in response to each of the one or more inbound emails being deemed malicious by the one or more machine learning models. According to one of the one or more dampening factors, the importance score of the user is decreased in response to the user sending fewer than a threshold number of outbound emails over the set period of time.

According to one of the one or more dampening factors, the importance score of the user is decreased in response to a frequency with which the user sends one or more outbound emails to one or more freemail addresses (i.e., email addresses hosted at free email domains) being greater than a threshold amount over the set period of time. According to one of the one or more dampening factors, the importance score of the user is decreased in response to a frequency with which the user is included in one or more external email threads by other user of the email system being less than a threshold over the set period of time.

According to one of the one or more dampening factors, the importance score of the user is decreased in response to a frequency with which the user sends one or more outbound emails being greater than a threshold amount over the set period of time. According to one of the one or more dampening factors, the importance score of the user is decreased in response to each batch of outbound emails sent by the user with a high frequency (e.g., a frequency greater than a threshold amount) over the set period of time. According to one of the one or more dampening factors, the importance score of the user is decreased in response to a frequency with which the user is included in one or more email threads that do not include any high importance user of the email system being greater than a threshold amount over the set period of time.

In step 1234, determining whether the user is a vip user based on the calculated importance score of the user. The user is characterized to be the vip user when the calculated importance score of the user is greater than a threshold amount. The user is determined not to be a vip user when the calculated importance score of the user is less than the threshold amount.

In step 1236, analyzing the one or more inbound emails having the user as a recipient. The one or more inbound emails are analyzed using one or more machine learning models.

In step 1238, detecting malicious emails. The malicious emails are detected based on results output by the one or more machine learning models.

In step 1240, causing one or more autonomous actions to be taken to mitigate emails deemed malicious. The emails are deemed malicious by the one or more machine learning models. The one or more autonomous actions are taken when a threat risk parameter from an assessment module cooperating with the one or more machine learning models is equal to or above an actionable threshold. The one or more autonomous actions are based on one or more vip-specific rules if the user is characterized to be the vip user, and the one or more autonomous actions are based on one or more non-vip-specific rules if the user is determined not to be a vip user.

In step 1242, notifying a human administrator if the user is characterized to be the vip user and the one or more autonomous actions based on the one or more vip-specific rules have been taken.

In step 1244, recalculating, periodically, the importance score of the user. For example, the importance score of the user can be recalculated every 24 hours, every three weeks, etc.

In step 1246, redetermining, periodically, whether the user is a vip user. For example, whether the user is a vip user can be redetermined every 24 hours, every three weeks, etc.

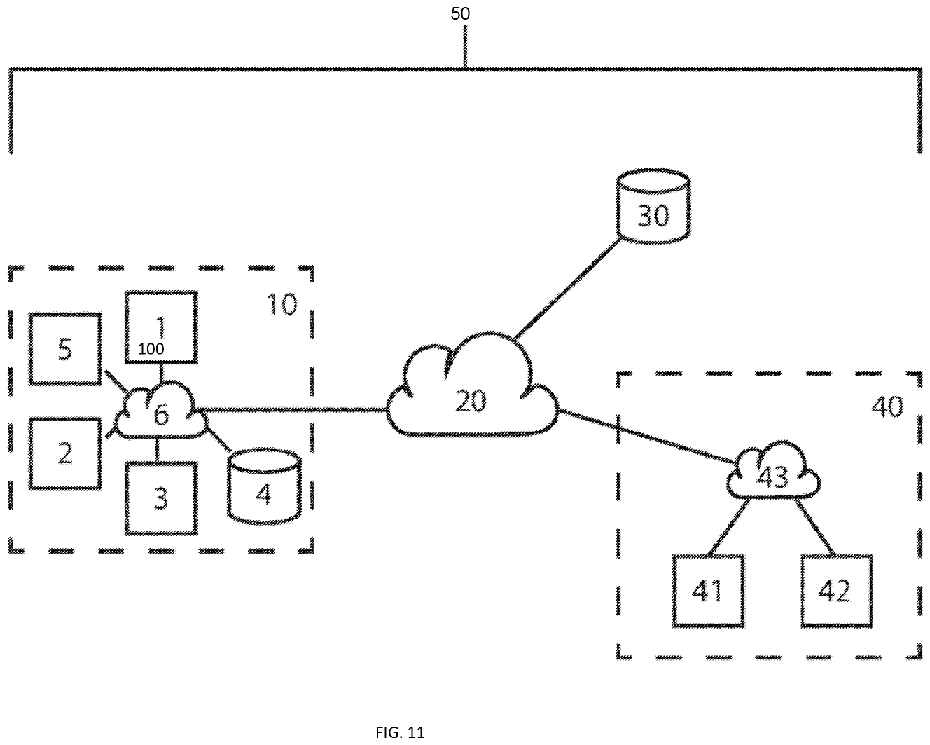

FIG. 11 illustrates an example of the Artificial Intelligence based cyber security appliance 100 using a cyber threat analyst module 125 104 to protect an example network. The example network of computer systems 50 uses a cyber security appliance 100. The system depicted is a simplified illustration, which is provided for ease of explanation. The system 50 comprises a first computer system 10 within a building, which uses the threat detection system to detect and thereby attempt to prevent threats to computing devices within its bounds.

The first computer system 10 comprises three computers 1, 2, 3, a local server 4, and a multifunctional device 5 that provides printing, scanning and facsimile functionalities to each of the computers 1, 2, 3. All of the devices within the first computer system 10 are communicatively coupled via a Local Area Network 6. Consequently, all of the computers 1, 2, 3 are able to access the local server 4 via the LAN 6 and use the functionalities of the MFD 5 via the LAN 6.

The LAN 6 of the first computer system 10 is connected to the Internet 20, which in turn provides computers 1, 2, 3 with access to a multitude of other computing devices 18 including server 30 and second computer system 40. The second computer system 40 also includes two computers 41, 42, connected by a second LAN 43.

In this exemplary embodiment of the cyber security appliance 100, computer 1 on the first computer system 10 has the electronic hardware, modules, models, and various software processes of the cyber security appliance 100; and therefore, runs threat detection for detecting threats to the first computer system. As such, the computer system includes one or more processor units arranged to run the steps of the process described herein, memory storage components required to store information related to the running of the process, as well as a network interface for collecting the required information for the probes and other sensors collecting data from the network under analysis.

The cyber security appliance 100 in computer 1 builds and maintains a dynamic, ever-changing model of the ‘normal behavior’ of each user and machine within the system 10. The approach is based on Bayesian mathematics, and monitors all interactions, events and communications within the system 10—which computer is talking to which, files that have been created, networks that are being accessed.

For example, computer 2 is based in a company's San Francisco office and operated by a marketing employee who regularly accesses the marketing network, usually communicates with machines in the company's U.K. office in second computer system 40 between 9.30 AM and midday, and is active from about 8:30 AM until 6 PM.

The same employee virtually never accesses the employee time sheets, very rarely connects to the company's Atlanta network and has no dealings in South-East Asia. The security appliance takes all the information that is available relating to this employee and establishes a‘pattern of life’ for that person and the devices used by that person in that system, which is dynamically updated as more information is gathered. The model of the normal pattern of life for an entity in the network under analysis is used as a moving benchmark, allowing the cyber security appliance 100 to spot behavior on a system that seems to fall outside of this normal pattern of life, and flags this behavior as anomalous, requiring further investigation and/or autonomous action.

The cyber security appliance 100 is built to deal with the fact that today's attackers are getting stealthier, and an attacker/malicious agent may be ‘hiding’ in a system to ensure that they avoid raising suspicion in an end user, such as by slowing their machine down.

The machine learning model(s) in the cyber security appliance 100 builds a sophisticated ‘pattern of life’—that understands what represents normality for every person, device, and network activity in the system being protected by the cyber security appliance 100.

The self-learning algorithms in the AI can, for example, understand each node's (user account, device, etc.) in an organization's normal patterns of life in about a week, and grows more bespoke with every passing minute. Conventional AI typically relies solely on identifying threats based on historical attack data and reported techniques, requiring data to be cleansed, labelled, and moved to a centralized repository. The detection engine self-learning AI can learn “on the job” from real-world data occurring in the system and constantly evolves its understanding as the system's environment changes. The Artificial Intelligence can use machine learning algorithms to analyze patterns and ‘learn’ what is the ‘normal behavior’ of the network by analyzing data on the activity on the network at the device and employee level. The unsupervised machine learning does not need humans to supervise the learning in the model but rather discovers hidden patterns or data groupings without the need for human intervention. The unsupervised machine learning discovers the patterns and related information using the unlabeled data monitored in the system itself. Unsupervised learning algorithms can include clustering, anomaly detection, neural networks, etc. Unsupervised Learning can break down features of what it is analyzing (e.g., a network node of a device or user account), which can be useful for categorization, and then identify what else has similar or overlapping feature sets matching to what it is analyzing.

The cyber security appliance 100 can use unsupervised machine learning to works things out without pre-defined labels. In the case of sorting a series of different entities, such as animals, the system analyzes the information and works out the different classes of animals. This allows the system to handle the unexpected and embrace uncertainty when new entities and classes are examined. The modules and models of the cyber security appliance 100 do not always know what they are looking for, but can independently classify data and detect compelling patterns.

The cyber security appliance 100's unsupervised machine learning methods do not require training data with pre-defined labels. Instead, they are able to identify key patterns and trends in the data, without the need for human input. The advantage of unsupervised learning in this system is that it allows computers to go beyond what their programmers already know and discover previously unknown relationships. The unsupervised machine learning methods can use a probabilistic approach based on a Bayesian framework. The machine learning allows the cyber security appliance 100 to integrate a huge number of weak indicators/low threat values by themselves of potentially anomalous network behavior to produce a single clear overall measure of these correlated anomalies to determine how likely a network device is to be compromised. This probabilistic mathematical approach provides an ability to understand important information, amid the noise of the network—even when it does not know what it is looking for.

The cyber security appliance 100 can use a Recursive Bayesian Estimation to combine these multiple analyzes of different measures of network behavior to generate a single overall/comprehensive picture of the state of each device, the cyber security appliance 100 takes advantage of the power of Recursive Bayesian Estimation (RBE) via an implementation of the Bayes filter.

Using RBE, the cyber security appliance 100's AI models are able to constantly adapt themselves, in a computationally efficient manner, as new information becomes available to the system. The cyber security appliance 100's AI models continually recalculate threat levels in the light of new evidence, identifying changing attack behaviors where conventional signature based methods fall down.

Training a model can be accomplished by having the model learn good values for all of the weights and the bias for labeled examples created by the system, and in this case; starting with no labels initially. A goal of the training of the model can be to find a set of weights and biases that have low loss, on average, across all examples.

The AI classifier can receive supervised machine learning with a labeled data set to learn to perform their task as discussed herein. An anomaly detection technique that can be used is supervised anomaly detection that requires a data set that has been labeled as “normal” and “abnormal” and involves training a classifier. Another anomaly detection technique that can be used is an unsupervised anomaly detection that detects anomalies in an unlabeled test data set under the assumption that the majority of the instances in the data set are normal, by looking for instances that seem to fit least to the remainder of the data set. The model representing normal behavior from a given normal training data set can detect anomalies by establishing the normal pattern and then test the likelihood of a test instance under analysis to be generated by the model. Anomaly detection can identify rare items, events or observations which raise suspicions by differing significantly from the majority of the data, which includes rare objects as well as things like unexpected bursts in activity.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory memory storage devices in an executable format to be executed by one or more processor units. The computer readable medium may be non-transitory and does not include radio or other carrier waves. The computer readable medium could be, for example, a physical computer readable medium such as semiconductor memory or solid state memory, magnetic tape, a removable computer diskette, a random access memory (RAM), a read-only memory (ROM), a rigid magnetic disc, and an optical disk, such as a CD-ROM, CD-R/W or DVD.

The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

A computing system can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit.

Computing Devices

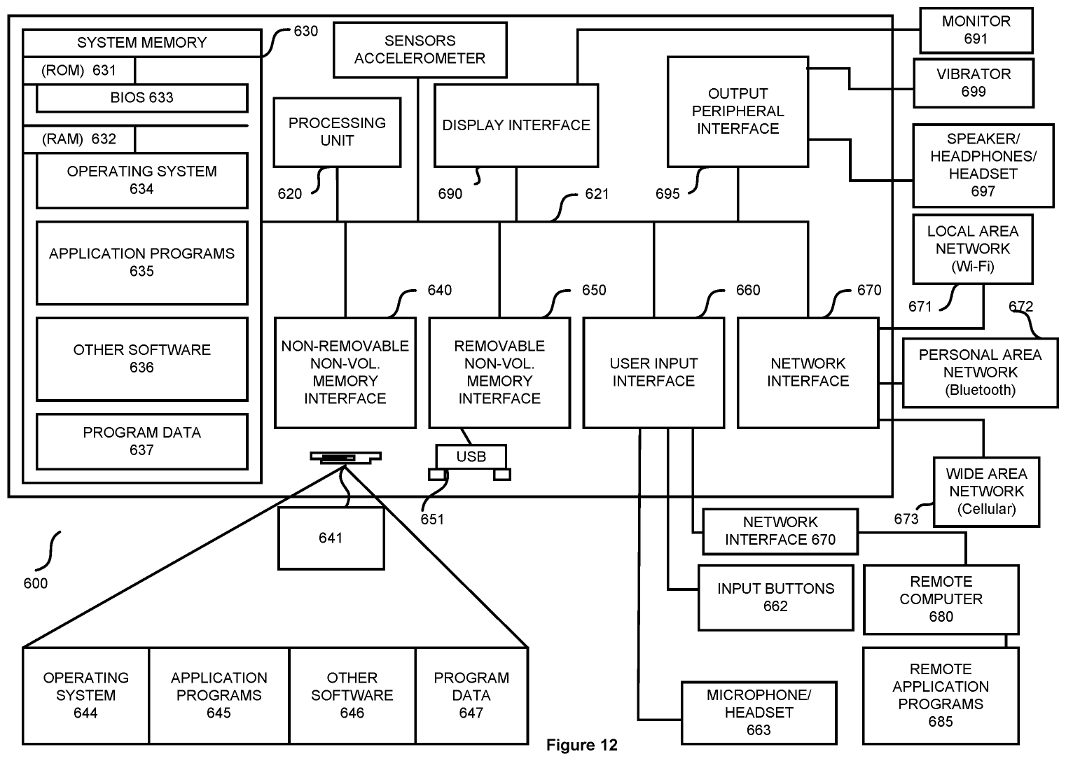

FIG. 12 illustrates a block diagram of an embodiment of one or more computing devices that can be a part of an embodiment of the Artificial Intelligence based cyber security appliance discussed herein.

The computing device may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this design implemented in software 644, 645, 646 are stored in the one or more memories 630-632 and are executed by the one or more processor units 620. The processing unit 620 may have one or more processing cores, which couples to a system bus 621 that couples various system components including the system memory 630. The system bus 621 may be any of several types of bus structures selected from a memory bus, an interconnect fabric, a peripheral bus, and a local bus using any of a variety of bus architectures.

Computing device 602 typically includes a variety of computing machine-readable media. Machine-readable media can be any available media that can be accessed by computing device 602 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 602. Transitory media such as wireless channels are not included in the machine-readable media. Machine-readable media typically embody computer readable instructions, data structures, and other executable software.

In an example, a volatile memory drive 641 is illustrated for storing portions of the operating system 644, application programs 645, other executable software 646, and program data 647.

A user may enter commands and information into the computing device 602 through input devices such as a keyboard, touchscreen, or software or hardware input buttons 662, a microphone 663, a pointing device and/or scrolling input component, such as a mouse, trackball or touch pad 661. The microphone 663 can cooperate with speech recognition software. These and other input devices are often connected to the processing unit 620 through a user input interface 660 that is coupled to the system bus 621, but can be connected by other interface and bus structures, such as a lighting port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibration device 699, and other output devices, which may be connected through an output peripheral interface 695.

The computing device 602 can operate in a networked environment using logical connections to one or more remote computers/client devices, such as a remote computing system 680. The remote computing system 680 can a personal computer, a mobile computing device, a server, a router, a network PC, a peer device or other common network node, and typically includes many or all of the elements described above relative to the computing device 602. The logical connections can include a personal area network (PAN) 672 (e.g., Bluetooth®), a local area network (LAN) 671 (e.g., Wi-Fi), and a wide area network (WAN) 673 (e.g., cellular network). Such networking environments are commonplace in offices, enterprise-wide computer networks, intranets and the Internet. A browser application and/or one or more local apps may be resident on the computing device and stored in the memory.

When used in a LAN networking environment, the computing device 602 is connected to the LAN 671 through a network interface 670, which can be, for example, a Bluetooth® or Wi-Fi adapter. When used in a WAN networking environment (e.g., Internet), the computing device 602 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing device 602, or portions thereof, may be stored in the remote memory storage device. By way of example, and not limitation, remote application programs 685 as reside on remote computing device 680. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A module is a core component of a complex system consisting of hardware and/or software that is capable of performing its function discretely from other portions of the entire complex system but designed to interact with the other portions of the entire complex system. Note, many functions performed by electronic hardware components can be duplicated by software emulation. Thus, a software program written to accomplish those same functions can emulate the functionality of the hardware components in the electronic circuitry.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. A cyber security appliance to protect an email system, comprising:
a user importance scoring module configured to calculate an importance score of a user of the email system based on a number of new inbound senders associated with one or more inbound emails having the user as a recipient over a set period of time and 1) one or more enhancing factors each of which increases the importance score of the user, 2) one or more dampening factors each of which reduces the importance score of the user, or 3) a combination thereof, wherein a greater number of the new inbound senders corresponds to a higher importance score that corresponds to a higher level of importance of the user;
a very important person (vip) determination module communicatively coupled to the user importance scoring module, where the vip determination module is configured to determine whether the user is a vip user based on the calculated importance score of the user, wherein the user is characterized to be the vip user when the calculated importance score of the user is greater than a threshold amount, and the user is determined not to be the vip user when the calculated importance score of the user is less than the threshold amount;
one or more machine learning models configured to analyze the one or more inbound emails having the user as the recipient and then output results to detect malicious emails; and
an autonomous response module communicatively coupled to the vip determination module, where the autonomous response module is configured to cause one or more autonomous actions to be taken to mitigate emails deemed malicious by the one or more machine learning models when a threat risk parameter from an assessment module cooperating with the one or more machine learning models is equal to or above an actionable threshold, wherein the one or more autonomous actions are based on one or more vip-specific rules if the user is characterized to be the vip user, and the one or more autonomous actions are based on one or more non-vip-specific rules if the user is determined not to be a vip user, where any software utilized by the user importance scoring module, the vip determination module, the machine learning models, the autonomous response module, and the assessment module is configured to be stored on one or more non-transitory machine readable mediums in a format to be executed by one or more processor units.

2. The cyber security appliance of claim 1, further comprising a communication module configured to notify a human administrator when the user is characterized to be the vip user and the one or more autonomous actions based on the one or more vip-specific rules have been taken.

3. The cyber security appliance of claim 1, wherein according to one of the one or more enhancing factors, the importance score of the user is increased in response to each of the one or more inbound emails being associated with fewer than a first threshold number of recipients, and
where the new inbound senders are new to the email system.

4. The cyber security appliance of claim 1, wherein according to one of the one or more enhancing factors, the importance score of the user is increased in response to each of the one or more inbound emails being deemed malicious by the one or more machine learning models.

5. The cyber security appliance of claim 1, wherein according to one of the one or more dampening factors, the importance score of the user is decreased in response to a frequency with which the user sends one or more outbound emails being greater than a first threshold over the set period of time.

6. The cyber security appliance of claim 1, wherein according to one of the one or more dampening factors, the importance score of the user is decreased in response to each batch of outbound emails sent by the user with a high frequency amount over the set period of time.

7. The cyber security appliance of claim 1, wherein according to one of the one or more dampening factors, the importance score of the user is decreased in response to the user sending fewer than a first threshold number of outbound emails over the set period of time.

8. The cyber security appliance of claim 1, wherein according to one of the one or more dampening factors, the importance score of the user is decreased in response to a frequency with which the user sends one or more outbound emails to one or more freemail addresses being greater than a first threshold over the set period of time.

9. The cyber security appliance of claim 1, wherein according to one of the one or more dampening factors, the importance score of the user is decreased in response to a frequency with which the user is included in one or more external email threads by other user of the email system being less than a first threshold over the set period of time.

10. The cyber security appliance of claim 1, wherein according to one of the one or more dampening factors, the importance score of the user is decreased in response to a frequency with which the user is included in one or more email threads that do not include any high importance user of the email system being greater than a first threshold over the set period of time.

11. The cyber security appliance of claim 1, wherein the user importance scoring module configured to periodically recalculate the importance score of the user, and the vip determination module is configured to periodically redetermine whether the user is a vip user.

12. A non-transitory machine readable medium configured to store instructions in a format when executed by one or more processor units causes operations as follows, comprising:
calculating an importance score of a user of an email system based on a number of new inbound senders associated with one or more inbound emails having the user as a recipient over a set period of time and 1) one or more enhancing factors each of which increases the importance score of the user, 2) one or more dampening factors each of which reduces the importance score of the user, or 3) a combination thereof, wherein a greater number of the new inbound senders corresponds to a higher importance score that corresponds to a higher level of importance of the user;
determining whether the user is a very important person (vip) user based on the calculated importance score of the user, wherein the user is characterized to be the vip user when the calculated importance score of the user is greater than a threshold amount, and the user is determined not to be the vip user when the calculated importance score of the user is less than the threshold amount;
using one or more machine learning models to analyze the one or more inbound emails having the user as the recipient and then output results to detect malicious emails; and
causing one or more autonomous actions to be taken to mitigate emails deemed malicious by the one or more machine learning models when a threat risk parameter is equal to or above an actionable threshold, wherein the one or more autonomous actions are based on one or more vip-specific rules when the user is characterized to be the vip user, and the one or more autonomous actions are based on one or more non-vip-specific rules when the user is determined not to be the vip user.

13. The non-transitory machine readable medium of claim 12, the medium being configured to store instructions in a format when executed by one or more processor units causes further operations as follows, comprising:
notifying a human administrator when the user is characterized to be the vip user and the one or more autonomous actions based on the one or more vip-specific rules have been taken.

14. A method for a cyber security appliance to protect an email system, comprising:
calculating an importance score of a user of the email system based on a number of new inbound senders associated with one or more inbound emails having the user as a recipient over a set period of time and 1) one or more enhancing factors each of which increases the importance score of the user, 2) one or more dampening factors each of which reduces the importance score of the user, or 3) a combination thereof, wherein a greater number of the new inbound senders corresponds to a higher importance score that corresponds to a higher level of importance of the user;
determining whether the user is a very important person (vip) user based on the calculated importance score of the user, wherein the user is characterized to be the vip user when the calculated importance score of the user is greater than a threshold amount, and the user is determined not to be the vip user when the calculated importance score of the user is less than the threshold amount;
using one or more machine learning models to analyze the one or more inbound emails having the user as the recipient and then output results to detect malicious emails; and
causing one or more autonomous actions to be taken to mitigate emails deemed malicious by the one or more machine learning models when a threat risk parameter is equal to or above an actionable threshold, wherein the one or more autonomous actions are based on one or more vip-specific rules when the user is characterized to be the vip user, and the one or more autonomous actions are based on one or more non-vip-specific rules when the user is determined not to be the vip user.

15. The method of claim 14, further comprising:
notifying a human administrator when the user is characterized to be the vip user and the one or more autonomous actions based on the one or more vip-specific rules have been taken.

16. The method of claim 14, wherein according to one of the one or more enhancing factors, the importance score of the user is increased in response to each of the one or more inbound emails being associated with fewer than a first threshold number of recipients.

17. The method of claim 14, wherein according to one of the one or more enhancing factors, the importance score of the user is increased in response to each of the one or more inbound emails being deemed malicious by the one or more machine learning models.

18. The method of claim 14, wherein according to one of the one or more dampening factors, the importance score of the user is decreased in response to a frequency with which the user sends one or more outbound emails being greater than a first threshold over the set period of time.

19. The method of claim 14, wherein according to one of the one or more dampening factors, the importance score of the user is decreased in response to each batch of outbound emails sent by the user with a high frequency amount over the set period of time.

20. The method of claim 14, wherein according to one of the one or more dampening factors, the importance score of the user is decreased in response to the user sending fewer than a first threshold number of outbound emails over the set period of time.
